(19) United States
(12) Patent Application Publication
(10) Pub. No.: US 2017/0041784 A1
(43) Pub. Date: Feb. 9, 2017

(54) INFORMATION PROCESSING APPARATUS, INFORMATION PROCESSING SYSTEM, METHOD FOR AUTHENTICATION, AND MEDIUM

(71) Applicant: Genki WATANABE, Tokyo (JP)

(72) Inventor: Genki WATANABE, Tokyo (JP)

(73) Assignee: Ricoh Company, Ltd., Tokyo (JP)

(21) Appl. No.: 15/205,685

(22) Filed: Jul. 8, 2016

(30) Foreign Application Priority Data
Aug. 7, 2015 (JP) 2015-157784
May 31, 2016 (JP) 2016-109031

(51) Int. Cl. H04W 12/06; G06K 9/00; H04L 29/06; H04N 5/232

(52) U.S. Cl. CPC H04W 12/06; H04N 5/232; G06K 9/00892; H04L 63/08

(57) ABSTRACT

An information processing apparatus includes a wireless communication unit configured to obtain predetermined information from a wireless tag; a wireless authentication unit configured to authenticate the wireless tag, based on the obtained predetermined information and first user information registered in advance; an imaging unit configured to capture an image by using an imaging device; an image authentication unit configured to authenticate a user captured in the image, based on the captured image and second user information registered in advance; and an apparatus authentication unit configured to permit a user to use the information processing apparatus in a case where a user of the wireless tag authenticated for permission by the wireless authentication unit, is a same user as the user authenticated for permission by the image authentication unit.

### BACKGROUND OF THE INVENTION

1. Field of the Invention

The present disclosure relates to an information processing apparatus, an information processing system, a method for authentication, and a medium.

2. Description of the Related Art

In recent years, as methods for authenticating users, authentication technologies such as face authentication and the like, which do not require an operation such as inputting a password or the like, and can prevent identity fraud caused by loss or theft of an IC card and the like, have become popular.

For example, an image processing apparatus has been known that compares and verifies information generated from a face image obtained by capturing an area that includes the face of a user, with authentication information registered in advance, to authenticate the user (see, for example, Patent Document 1).

However, compared to popular methods for authentication that use IC cards or the like, a method for authentication that uses a captured image, for example, face authentication, has lower precision of authentication in general, and has difficulty in improving the precision of authentication.

### SUMMARY OF THE INVENTION

According to an embodiment, an information processing apparatus includes a wireless communication unit configured to obtain predetermined information from a wireless tag; a wireless authentication unit configured to authenticate the wireless tag, based on the obtained predetermined information and first user information registered in advance; an imaging unit configured to capture an image by using an imaging device; an image authentication unit configured to authenticate a user captured in the image, based on the captured image and second user information registered in advance; and an apparatus authentication unit configured to permit a user to use the information processing apparatus in a case where a user of the wireless tag authenticated for permission by the wireless authentication unit, is a same user as the user authenticated for permission by the image authentication unit.

### BRIEF DESCRIPTION OF DRAWINGS

FIG. 1 is a diagram illustrating an example of a configuration of an information processing system according to an embodiment;

FIG. 2 is a diagram illustrating an example of a detection range of an RF tag reader according to an embodiment;

FIG. 3 is a diagram illustrating an example of a hardware configuration of an image forming apparatus according to an embodiment;

FIG. 4 is a diagram illustrating an example of a software configuration of an image forming apparatus according to an embodiment;

FIG. 5 is a diagram illustrating an example of a functional configuration of an image forming apparatus according to a first embodiment;

FIG. 6 is a diagram illustrating another example of a functional configuration of an image forming apparatus according to the first embodiment;

FIG. 7 is a table illustrating an example of user information according to the first embodiment;

FIGS. 8A-8B are tables illustrating another example of user information according to the first embodiment;

FIG. 9 is a flowchart illustrating an example of a process for authentication by a wireless authentication unit according to the first embodiment;

FIG. 10 is a flowchart illustrating an example of a process for authentication by an image authentication unit according to the first embodiment;

FIGS. 11A-11B are diagrams for illustrating an example of face authentication according to the first embodiment;

FIG. 12 is a flowchart illustrating an example of a process for authentication by an image forming apparatus according to the first embodiment;

FIG. 13 is a diagram illustrating an example of a detection range of an RF tag reader according to a second embodiment;

FIG. 14 is a diagram illustrating an example of a functional configuration of an image forming apparatus according to the second embodiment;

FIG. 15 is a flowchart illustrating an example of a process for authentication by an image forming apparatus according to the second embodiment;

FIG. 16 is a flowchart illustrating an example of a process for authentication by an image forming apparatus according to a third embodiment;

FIG. 17 is a flowchart illustrating an example of a process for authentication by a wireless authentication unit according to a fourth embodiment;

FIG. 18 is a flowchart illustrating an example of a process for authentication by an image authentication unit according to the fourth embodiment; and

FIG. 19 is a flowchart illustrating an example of a process for authentication by an image forming apparatus according to a fifth embodiment.

### DETAILED DESCRIPTION OF THE EMBODIMENTS

In the following, embodiments will be described with reference to the drawings.

According to an embodiment, an information processing apparatus can be provided that makes it easy to improve precision of authentication in a method for authentication that uses a captured image such as face authentication and the like.

<Configuration of System>

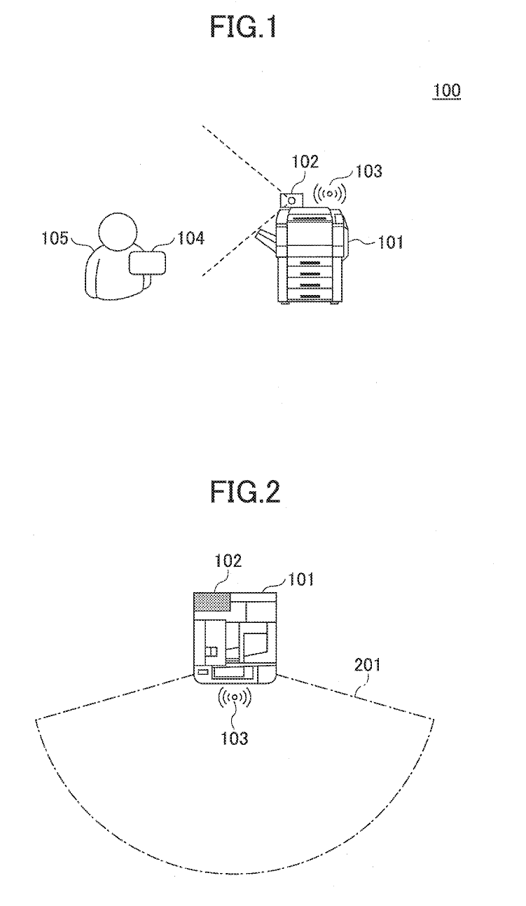

FIG. 1 is a diagram illustrating an example of a configuration of an information processing system according to an embodiment. In FIG. 1, an information processing system 100 includes an image forming apparatus 101 and a radio-frequency identification (RFID) tag 104 held by a user 105.

The image forming apparatus 101 is an example of an information processing apparatus according to the embodiment, for example, a multifunction peripheral (MFP) including functions of a printer, a scanner, a copier, and a facsimile machine, or an image forming apparatus such as a printer.

The image forming apparatus 101 includes an RF tag reader 103 to receive predetermined information such as a tag ID from the RFID tag 104 located within a predetermined range, and a camera 102 to capture an image.

RFID is a technology for executing near field communication between the RFID tag 104 storing predetermined information such as a tag ID, and the RF tag reader 103, by using an electromagnetic field or a radio wave, which is an example of near field communication.

If the RFID tag 104 is, for example, a passive tag, the RF tag reader 103 emits a predetermined radio wave in a detection range (a predetermined range) of the RF tag reader 103, which will be described later. In response to receiving the radio wave emitted from the RF tag reader 103, the RFID tag 104 operates on the received radio wave as the power source, to transmit predetermined information such as the tag ID stored in advance to the RF tag reader 103.

A passive tag operates on a radio wave from the RF tag reader 103 as the energy source, does not need to have a battery built in, and the RFID tag 104 is a passive tag. The antenna of a passive tag reflects a part of the radio wave from the RF tag reader 103, and information such as the tag ID is returned by this reflected wave. Since the strength of this reflection is very small, a passive tag covers a shorter communication distance than an active tag that transmits a radio wave by the electric power of the device of its own, but has a lower cost, and operates virtually permanently.

The camera 102 is a camera (an imaging unit) that is installed so that an image captured by the camera 102 contains, for example, a user who uses the image forming apparatus 101.

FIG. 2 is a diagram illustrating an example of a detection range of the RF tag reader 103 according to an embodiment. FIG. 2 illustrates a detection range 201 of the RF tag reader 103 viewed from the upper side of the image forming apparatus 101. In the example in FIG. 2, the image forming apparatus 101 includes, for example, a patch antenna in the image forming apparatus 101, to form a fan-shaped detection range in front of the image forming apparatus 101 (the down direction in FIG. 2).

Thus, for example, if the user 105 holding the RFID tag 104 approaches the image forming apparatus 101 on the front side, and comes within a predetermined distance (for example, 3 m), the predetermined information (for example, the tag ID) stored in the RFID tag 104 is automatically transmitted to the image forming apparatus 101.

In the embodiment, the image forming apparatus 101 stores information about users registered in advance, to execute authentication of the RFID tag 104 (first authentication), based on the tag ID received from the RFID tag 104 and the information about the users registered in advance.

Also, the image forming apparatus 101 executes face authentication of a user (second authentication), based on, for example, a face image of the user included in an image captured by the camera 102, and characteristic information about faces of the users registered in advance.

Further, if permissions are obtained by the first authentication and the second authentication, respectively, the image forming apparatus 101 executes user authentication (a third authentication) based on information about the user of the RFID tag 104 for which the permission has been obtained by the first authentication, and information about the user who has been permitted by the second authentication. If the user having the RFID tag 104 permitted by the first authentication is, for example, the same user as the user permitted by the second authentication, the image forming apparatus 101 permits the user to log in the image forming apparatus 101.

In this way, the image forming apparatus 101 permits the user to log in if permission has been obtained by both the wireless authentication by a wireless tag and the image authentication by the captured image, and the user permitted by the wireless authentication is the same user as the user permitted by the image authentication.

Thus, the image forming apparatus 101 according to the embodiment can improve precision of authentication in a method for authentication that uses a captured image such as face authentication, for a user 105 of the image forming apparatus 101 who is just holding the RFID tag 104.

Note that the system configuration in FIG. 1 is just an example.

The image forming apparatus 101 may be any one of information processing apparatuses that can authenticate a user, for example, a personal computer (PC), a tablet terminal, a smart phone, a game machine, or a video-conference apparatus. Also, the camera 102 and the RF tag reader 103 may be devices that are attached externally.

Also, the RFID tag 104 may be an active tag or a semi-active tag of RFID. Note that the RFID tag 104 is an example of a wireless tag. The wireless tag here may be a wireless terminal to execute communication by a short-distance wireless method different from RFID, for example, Bluetooth™ Low Energy (referred to as “BLE”, below) or near-field communication (NFC). Also, instead of the wireless tag, a mobile terminal having a wireless tag installed may be used.

The wireless tag may be, for example, an IC tag or an IC card other than the above devices. Also, as an example of a wireless authentication unit included in the image forming apparatus 101, a device that executes wireless authentication by using an IC tag reader or an IC card reader, may be considered other than the RFID reader 103.

In this case, when a user holds an IC tag or an IC card over an IC tag reader or an IC card reader installed in the image forming apparatus 101 (for example, within a distance about 10 cm), wireless authentication is executed.

Further, the face authentication may be any one of various methods for authentication that authenticate a user by using a captured image of the user and characteristic information about a living body part of the user, for example, fingerprint authentication, iris authentication, and vein authentication.

<Hardware Configuration>

(Hardware Configuration of Image Forming Apparatus)

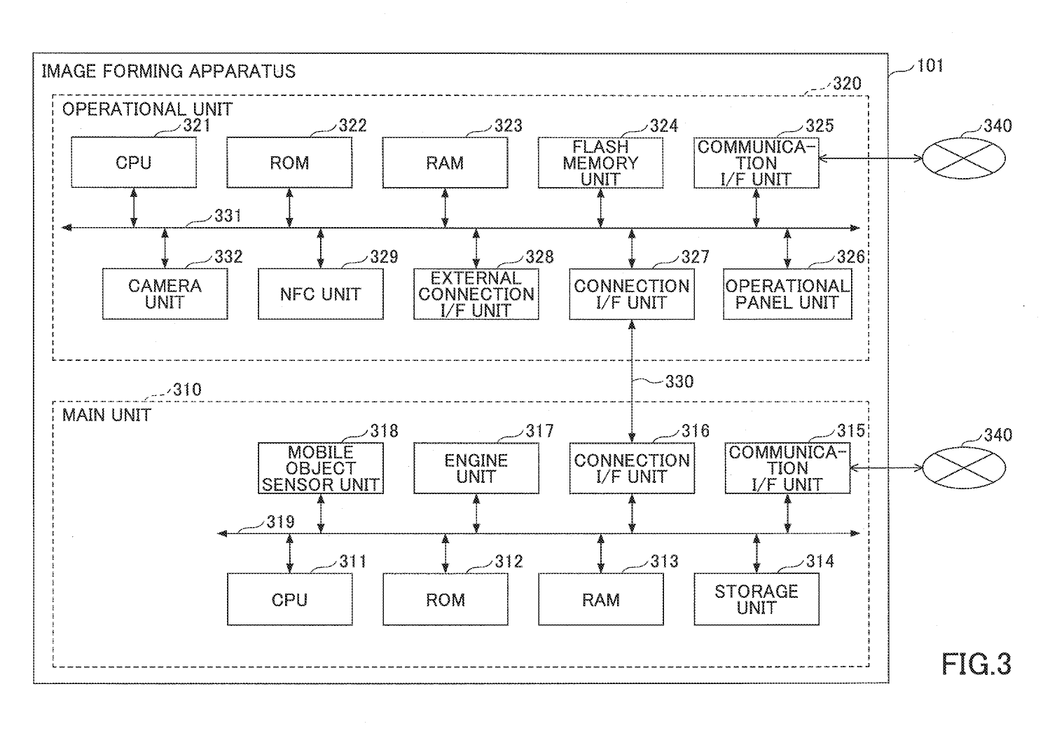

FIG. 3 is a diagram illustrating an example of a hardware configuration of the image forming apparatus 101 according to an embodiment. The image forming apparatus 101 includes a main unit 310 that implements various image forming functions, for example, a copy function, a scanner function, a fax function, and a printer function; and an operational unit 320 that receives a user operation. Note that the meaning of “receiving a user operation” here includes receiving information input along with the user operation (including a signal that represents coordinate values on a screen). The main unit 310 and the operational unit 320 are connected to communicate with each other via a dedicated communication channel 330. The communication channel 330 may be compliant with, for example, USB (Universal Serial Bus) standards, or any other standards regardless of wired or wireless.

Note that the main unit 310 can execute an operation that corresponds to an operation received by the operational unit 320. Also, the main unit 310 can communicate with an external apparatus such as a client PC, and can execute an operation that corresponds to an operation received from the external apparatus.

First, a hardware configuration of the main unit 310 will be described. As illustrated in FIG. 3, the main unit 310 includes a central processing unit (CPU) 311, a read-only memory (ROM) 312, a random access memory (RAM) 313, a storage unit 314, a communication interface (I/F) unit 315, a connection I/F unit 316, an engine unit 317, a mobile object sensor unit 318, and a system bus 319.

The CPU 311 controls operations of the main unit 310 as a whole. The CPU 311 executes programs stored in the ROM 312 or the storage unit 314 by using the RAM 313 as a work area, to control operations of the main unit 310 as a whole. The CPU 311 implements various functions, for example, the copy function, the scanner function, the fax function, and the printer function described above.

The ROM 312 is a non-volatile memory that stores, for example, a basic input/output system (BIOS) that is executed when the main unit 310 is activated, various settings, and the like. The RAM 313 is a volatile memory that is used as a work area of the CPU 311. The storage unit 314 is a non-volatile storage device that stores, for example, an operating system (OS), application programs, various data items, and the like, and may be constituted with, for example, a hard disk drive (HDD), a solid state drive (SSD), and the like.

The communication I/F unit 315 is a network interface for connecting the main unit 310 to a network 340, and for communicating with an external apparatus that is connected with the network 340. The connection I/F unit 316 is an interface to communicate with the operational unit 320 via the communication channel 330.

The engine unit 317 is hardware that executes general-purpose information processing to implement the functions of the copy function, the scanner function, the fax function, the printer function, and the like, and processing other than communication. The engine unit 317 includes, for example, a scanner (an image scanning unit) that scans and captures an image of a document, a plotter (an image forming unit) that executes printing on a sheet member such as paper, and a fax unit that executes fax communication. The engine unit 317 may further include specific optional units such as a finisher that sorts out printed sheet members, and an automatic document feeder (ADF) that feeds document sheets automatically.

The mobile object sensor unit 318 is a sensor that detects a mobile object within the detection range around the image forming apparatus 101, for example, a pyroelectricity sensor.

The system bus 319 is connected with the above elements, to transmit an address signal, a data signal, various control signals, and the like.

Next, a hardware configuration of the operational unit 320 will be described. As illustrated in FIG. 3, the operational unit 320 includes a CPU 321, a ROM 322, a RAM 323, a flash memory unit 324, a communication I/F unit 325, an operational panel unit 326, a connection I/F unit 327, an external connection I/F unit 328, a near-field communication (NFC) unit 329, a camera unit 332, and a system bus 331.

The CPU 321 controls operations of the operational unit 320 as a whole. The CPU 321 executes programs stored in the ROM 322 or the storage unit 324 by using the RAM 323 as a work area, to control operations of the operational unit 320 as a whole. The CPU 321 implements various functions, for example, displaying information (an image) depending on input received from the user.

The ROM 322 is a non-volatile memory that stores, for example, a basic input/output system (BIOS) that is executed when the operational unit 320 is activated, various settings, and the like. The RAM 323 is a volatile memory that is used as a work area of the CPU 321. The flash memory unit 324 is a non-volatile storage device that stores, for example, an OS, application programs, various data items, and the like.

The communication I/F unit 325 is a network interface for connecting the operational unit 320 to the network 340, and for communicating with an external apparatus that is connected with the network 340.

The operational panel unit 326 receives various input items in response to user operations, and displays various information items (for example, information depending on a received operation, information that represents an operational state of the image forming apparatus 101, and setting states). The operational panel unit 326 may be constituted with, for example, a liquid crystal display (LCD) having a touch panel function installed, but is not limited to such constitution. The operational panel unit 326 may be constituted with, for example, an organic electro-luminescence (EL) display having a touch panel function installed. Further, in addition to or instead of the above constitution, the operational panel unit 326 may include an operational unit such as hardware keys, and a display part such as a lamp.

The connection I/F unit 327 is an interface of communicating with the main unit 310 via the communication channel 330. The external connection I/F unit 328 is an interface for having an external apparatus connected, for example, USB.

The NFC unit 329 is a near-field communication device for communicating with a wireless tag within a predetermined communication range by near field communication. The NFC unit 329 includes, for example, the RF tag reader 103 in FIG. 1, and receives predetermined information from a passive RFID tag that returns a response to a radio wave transmitted from the NFC unit 329, or an active RFID tag that transmits a radio wave from the device itself. Also, the NFC unit 329 may be a BLE described above, an IC tag reader, or an IC card reader.

The camera unit 332 is an imaging device that captures an image within an imaging range.

The system bus 331 is connected with the above elements, to transmit an address signal, a data signal, various control signals, and the like.

<Software Configuration>

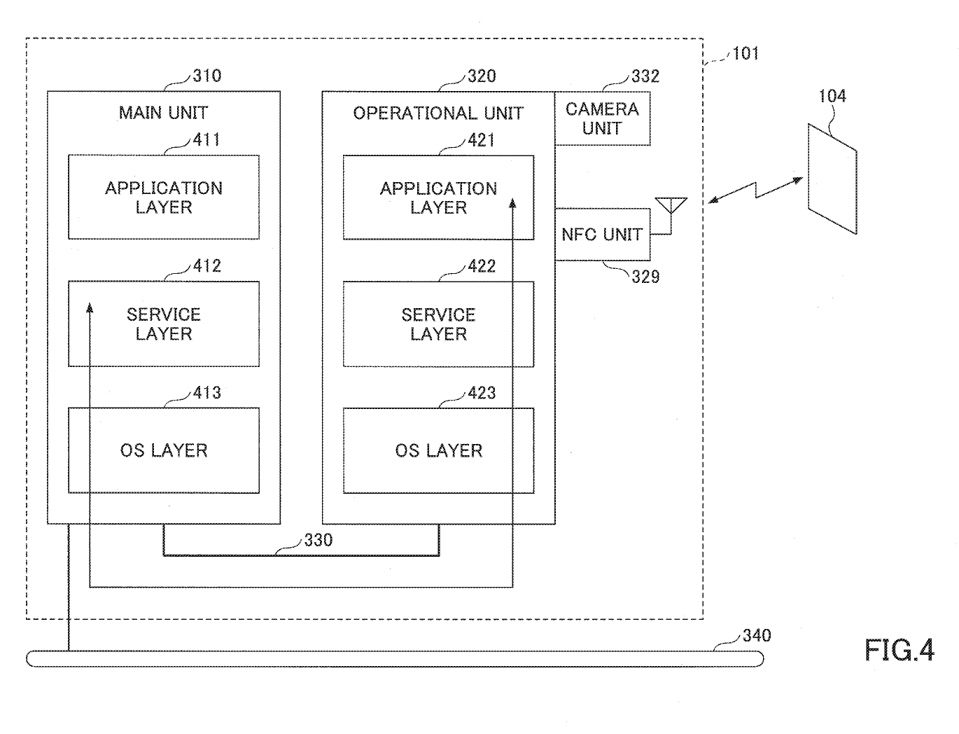

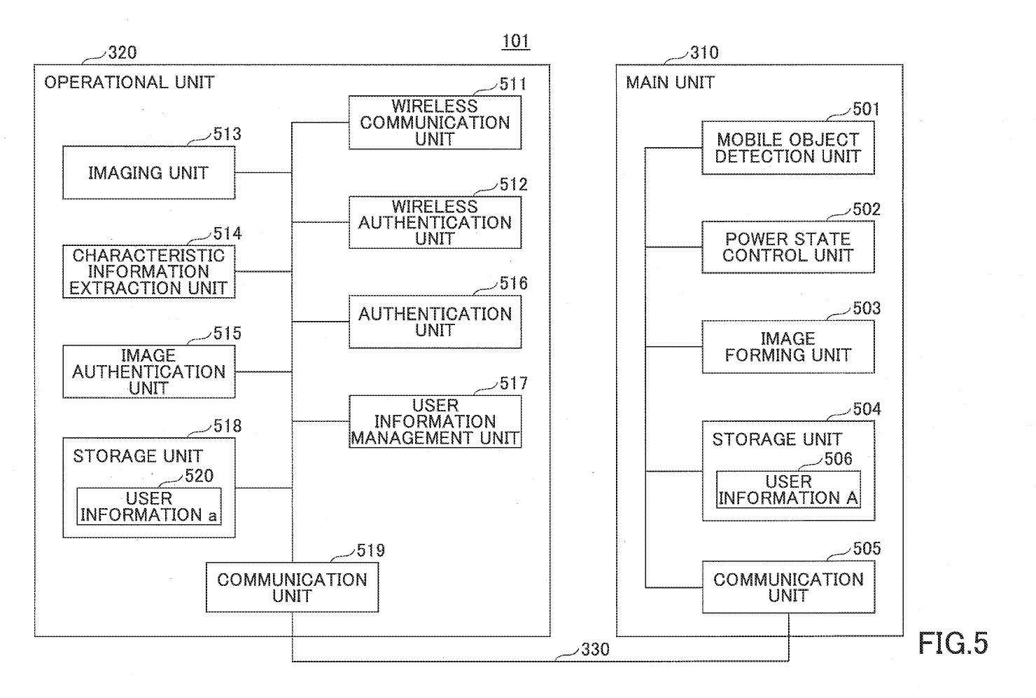

FIG. 4 is a diagram illustrating an example of a software configuration of the image forming apparatus 101 according to the embodiment.

As illustrated in FIG. 4, the main unit 310 includes an application layer 411, a service layer 412, and an OS layer 413. Entities in the application layer 411, the service layer 412, and the OS layer 413 are various software items that are stored in the ROM 312 and the storage unit 314. The CPU 311 executes these software items (programs) to provide various functions of the main unit 310.

The application layer 411 includes software applications that provide predetermined functions by having hardware resources operate. Applications include, for example, a copy application that provides a copy function, a scanner application that provides a scanner function, a fax application that provides a fax function, and a printer application that provides a printer function.

The service layer 412 is software that lies between the application layer 411 and the OS layer 413, to provide an interface for applications in the application layer 411 to use hardware resources included in the main unit 310. More specifically, the service layer 412 is software that provides functions to receive requests for operation of hardware resources, and a function to arbitrate received requests for operation. As requests for operation to be received by the service layer 412, capturing by a scanner, printing by a plotter, and the like may be considered.

Note that the interface functions by the service layer 412 are provided not only for the application layer 411 of the main unit 310, but also for the application layer 421 of the operational unit 320. In other words, the application layer 421 of the operational unit 320 can implement a function that uses a hardware resource (for example, the engine unit 317) of the main unit 310 via the interface functions of the service layer 412 of the main unit 310.

The OS layer 413 is basic software (an operating system) that provides basic functions to control hardware included in the main unit 310. The service layer 412 converts requests for using hardware resources from various applications into commands that can be interpreted by the OS layer 413, and transfers the converted commands to the OS layer 413. Then, the OS layer 413 executes the commands to have the hardware resources operate following the requests of the applications.

Similarly, the operational unit 320 includes an application layer 421, a service layer 422, and an OS layer 423. The application layer 421, the service layer 422, and the OS layer 423 included in the operational unit 320 have substantially the same hierarchical structure as the corresponding layers included in the main unit 310. However, functions provided by applications in the application layer 421 and types of requests for operations that can be received by the service layer 422 are different from the functions and the types in the main unit 310. Although applications in the application layer 421 may be software that provides predetermined functions to have hardware resources included in the operational unit 320 operate, the applications mainly provide functions of user interface (UI) for operations about the functions included in the main unit 310, and for displaying. Also, the applications in the application layer 421 provide an authentication function that uses the NFC unit 329, the camera unit 332, and the like included in the operational unit 320.

Note that in the embodiment, to make the functions independent, the software of the OS layer 413 on the side of the main unit 310 is different from the software of the OS layer 423 on the side of the operational unit 320. In other words, the main unit 310 and the operational unit 320 independently operate under different operating systems. For example, it is possible to use Linux (trademark) as the software of the OS layer 413 on the side of the main unit 310, and to use Android (trademark) as the software of the OS layer 423 on the side of the operational unit 320.

As described above, in the image forming apparatus 101 in the embodiment, since the main unit 310 and the operational unit 320 operate under different operating systems, communication between the main unit 310 and the operational unit 320 is not executed by inter-process communication, which is used for devices in a common apparatus, but executed by communication between different apparatuses. An operation to transfer information received by the operational unit 320 (contents of a command from a user) to the main unit 310 (command communication), an operation to indicate an event to the operational unit 320 by the main unit 310, and the like, correspond to such communication between different apparatuses. Here, the operational unit 320 may execute command communication to the main unit 310 to use a function of the main unit 310. Also, an event indicated to the operational unit 320 by the main unit 310 includes, for example, an execution state of an operation on the main unit 310, and contents set on the side of the main unit 310.

Also, in the embodiment, since power is supplied to the operational unit 320 from the main unit 310 via the communication channel 330, power can be controlled for the operational unit 320, separately (independently) from power control of the main unit 310.

<Functional Configuration>

FIG. 5 is a diagram illustrating an example of a functional configuration of the image forming apparatus 101 according to a first embodiment.

(Functional Configuration of Main Unit)

The main unit 310 of the image forming apparatus 101 includes a mobile object detection unit 501, a power state control unit 502, an image forming unit 503, a storage unit 504, and a communication unit 505.

The mobile object detection unit 501 is a unit to detect a mobile object (for example, a person) within a detection range (for example, around the image forming apparatus 101) by using the mobile object sensor unit 318, and is implemented by, for example, a program that runs on the CPU 311 in FIG. 3. If detecting a mobile object within the detection range, the mobile object detection unit 501 indicates to the power state control unit 502 that the mobile object has been detected.

The power state control unit 502 is a unit to control states of power of the operational unit 320 and the main unit 310, and is implemented by, for example, a program that runs on the CPU 311 in FIG. 3. If the image forming apparatus 101 has not been used, for example, over a preset time, the power state control unit 502 has the image forming apparatus 101 transition to a power-saving state in which power consumption is less than in a normal state in which an image forming process can be executed. In a power-saving state, for example, functions of the operational unit 320, and the engine unit 317 and the storage unit 314 of the main unit 310 may be stopped to reduce the power consumption.

Also, if the image forming apparatus 101 is in a power-saving state, and receives from the mobile object detection unit 501 an indication representing that a mobile object has been detected, the power state control unit 502 according to the embodiment has the operational unit 320 resume a normal state, in which a normal operation can be executed, from the power-saving state. The power state control unit 502 issues such an indication, for example, by a resume command to the operational unit 320 via the communication unit 505, to have the operational unit 320 resume a normal state from the power-saving state.

The image forming unit 503 is a unit to execute various image forming functions (for example, printing, copying, scanning, and fax) included in the image forming apparatus 101, and is implemented by, for example, the engine unit 317 in FIG. 3 and a program that runs on the CPU 311 in FIG. 3.

The storage unit 504 is a unit to store various information items including user information ‘A’ 506, which is information about users of the image forming apparatus 101 registered in advance, and is implemented by, for example, the storage unit 314 and the RAM 313 in FIG. 3 and a program that runs on the CPU 311 in FIG. 3.

The communication unit 505 is a unit to communicate with the operational unit 320, and is implemented by, for example, the connection I/F unit 316 in FIG. 3.

(Functional Configuration of Operation Unit)

The operational unit 320 of the image forming apparatus 101 includes a wireless communication unit 511, a wireless authentication unit 512, an imaging unit 513, a characteristic information extraction unit 514, an image authentication unit 515, an authentication unit 516, a user information management unit 517, a storage unit 518, and a communication unit 519.

The wireless communication unit 511 (a wireless communication unit) is a unit to receive predetermined information from a wireless tag within a predetermined range by near field communication using the NFC unit 329, and is implemented by, for example, a program that runs on the CPU 321 in FIG. 3. For example, the wireless communication unit 511 receives predetermined information, such as the tag ID of the RFID tag 104, from the RFID tag 104 in the detection range 201 of the RF tag reader 103 in FIG. 2.

The wireless authentication unit 512 (a wireless authentication unit) is a unit to authenticate a wireless tag that transmits the predetermined information, based on the predetermined information received by the wireless communication unit 511 and the user information registered in advance, and is implemented by, for example, a program that runs on the CPU 311 in FIG. 3. The wireless authentication unit 512 authenticates the RFID tag 104 based on, for example, the tag ID of the RFID tag 104 received by the wireless communication unit 511, the user information registered in advance (for example, user information ‘a’ 520 or the user information ‘A’ 506).

The wireless authentication unit 512 permits authentication of the RFID tag 104, for example, if the tag ID of the RFID tag 104 received by the wireless communication unit 511 is included in the user information registered in advance. Also, the wireless authentication unit 512 outputs information about the user (for example, identification information of the user) of the RFID tag 104 authenticated for permission, to the authentication unit 516 or the storage unit 518.

The imaging unit 513 is a unit to capture an image by using the camera unit 332, and is implemented by, for example, a program that runs on the CPU 321 in FIG. 3. The imaging unit 513 captures an image, for example, in a front direction of the image forming apparatus 101, to capture an image of a user in front of the image forming apparatus 101.

The characteristic information extraction unit 514 (a characteristic information extraction unit) is a unit to extract a face image or characteristic information of the face image if an image captured by the imaging unit 513 includes the face image, and is implemented by, for example, a program that runs on the CPU 321 in FIG. 3. Note that characteristic information of a face image includes, for example, information about a profile of the face, shapes and relative positions of parts such as eyes, nose, chin, cheekbone, and the like.

The image authentication unit 515 (an image authentication unit) is a unit to authenticate a user included in an image captured by the imaging unit 513, based on the image captured by the imaging unit 513 and the user information registered in advance, and is implemented by, for example, a program that runs on the CPU 321 in FIG. 3. The image authentication unit 515 executes, for example, face authentication of the user included in the image, based on the characteristic information about the face of the user extracted by the characteristic information extraction unit 514 in the image captured by the imaging unit 513, and the user information registered in advance (for example, the user information ‘a’ 520 or the user information ‘A’ 506).

The image authentication unit 515 permits authentication of a user included in an image, for example, if a characteristic information item corresponding to the characteristic information extracted by the characteristic information extraction unit 514 is included in the user information registered in advance. Also, the image authentication unit 515 outputs information about the user authenticated for permission (for example, identification information of the user) to the authentication unit 516 or the storage unit 518.

Note that the image authentication unit 515 in the embodiment may execute face authentication of a user, by using a publicly known face authentication technology (see, for example, Patent Document 1).

Further, the image authentication unit 515 may execute authentication of a user, by using various publicly known methods of image-based authentication of a user, for example, fingerprint authentication, iris authentication, and vein authentication, based on characteristic information about living body parts of the user included in an image captured by the imaging unit 513.

The authentication unit 516 (an apparatus authentication unit) authenticates a user, based on information about a user authenticated for permission by the wireless authentication unit 512, and information about a user authenticated for permission by the image authentication unit 515. The authentication unit 516 is implemented by, for example, a program that runs on the CPU 321 in FIG. 3. For example, if the user of a wireless tag (the RFID tag 104) authenticated for permission by the wireless authentication unit 512 is the same user as a user authenticated for permission by the image authentication unit 515, the authentication unit 516 permits the user to use the image forming apparatus 101.

As a preferable example, the authentication unit 516 permits the user to use the image forming apparatus 101, if the identification information of the user of the wireless tag authenticated for permission by the wireless authentication unit 512 is equivalent to the identification information of the user authenticated for permission by the image authentication unit 515.

Note that the identification information of the user obtained by the wireless authentication unit 512 may be considered to be equivalent to the identification information of the user obtained by the image authentication unit 515, not only if the two identification information items are completely equivalent to each other, but also if the two identification information items can be determined to be equivalent to each other substantially.

For example, if the identification information of the user obtained by the image authentication unit is an eight-digit employee ID, and the identification information of the user obtained by the wireless authentication unit 512 is a ten-digit login ID having two digits added to the employee ID, the two identification information items may be determined to be equivalent to each other.

In this way, if the identification information obtained by the wireless authentication unit 512 and the identification information obtained by the image authentication unit 515 are identification information about the same user, the authentication unit 516 may permit the user to use the image forming apparatus 101.

The communication unit 519 is a unit to communicate with the main unit 310, and is implemented by, for example, the connection I/F unit 327 in FIG. 3. The communication unit 519 has power supplied even if the operational unit 320 is in a power-saving state, and hence, can receive a resume request transmitted from the main unit 310.

The user information management unit 517 is a unit to manage the user information ‘a’ 520 stored in the storage unit 518, and is implemented by, for example, a program that runs on the CPU 321 in FIG. 3.

The storage unit 518 (a storage unit) stores various information items, for example, the user information ‘a’ 520, and is implemented by, for example, the flash memory unit 324 and the RAM 323 in FIG. 3 and a program that runs on the CPU 321 in FIG. 3.

Here, an example of the user information ‘a’ 520 will be described.

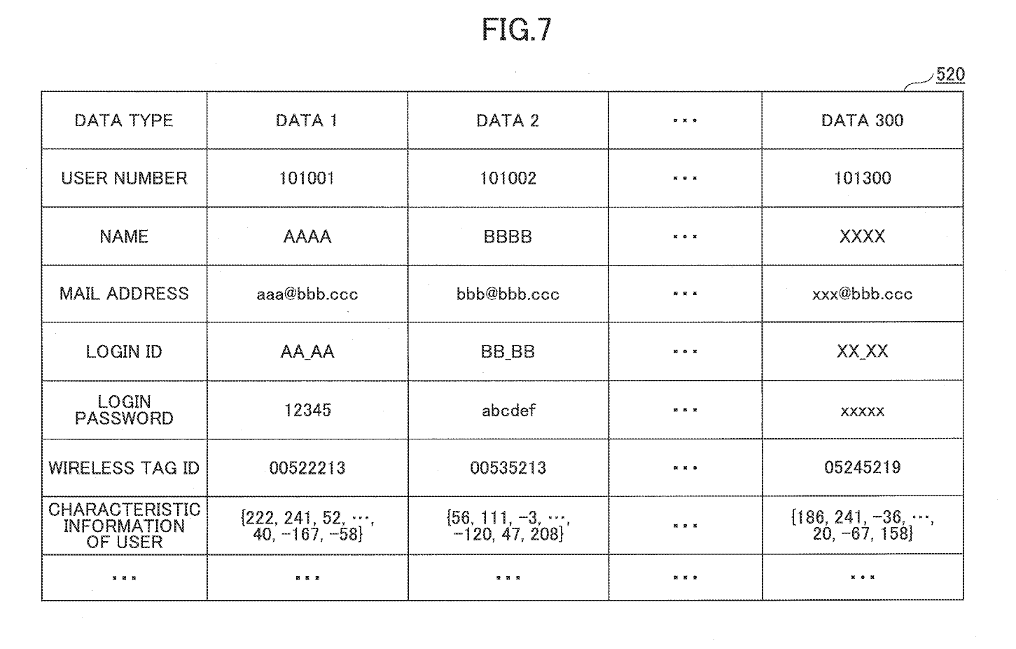

FIG. 7 is a table illustrating an example of the user information ‘a’ 520 according to the first embodiment. The user information ‘a’ 520 is an example of user information registered in advance. In the example in FIG. 7, the user information ‘a’ 520 includes information about “user number”, “name”, “mail address”, “login ID”, “login password”, “wireless tag ID”, and “characteristic information of user”.

The “user number” is an identification number (or identification information) specific to a data block for each user, for example, a serial number counted when registering information of users into the user information ‘a’ 520, and is an example of identification information specific to each user. The “user number” may be identification information of a user, for example, an employee ID.

The “name” is a name of the user. The “mail address” is a mail address of the user. The “login ID” and the “login password” are examples of authentication information for the user to log in the image forming apparatus 101.

The “wireless tag ID” is a tag ID (identification information) transmitted by the RFID tag 104 held by the user, and represented by, for example, eight digits. Note that the “wireless tag ID” is an example of predetermined information transmitted from a wireless tag, and the predetermined information may include information other than digits, for example, identification information of the user.

The “characteristic information of user” is characteristic information about the face of the user of the image forming apparatus 101, for example, information about a profile of the face, shapes and relative positions of parts such as eyes, nose, chin, cheekbone, and the like, which are obtained and stored in advance. Note that the data format of the characteristic information of the users illustrated in FIG. 7 is just an example, and another format may be adopted discretionally.

The storage unit 518 of the operational unit 320 may store, for example, 300 to 1,800 records of the user information ‘a’ 520 illustrated in FIG. 7. For example, the user information management unit 517 of the operational unit 320 stores at least a part of the user information ‘A’ 506 stored in the storage unit 504 of the main unit 310 as the user information a′ 520 in the storage unit 518 of the operational unit 320. This makes it possible for the wireless authentication unit 512 and the image authentication unit 515 to read the user information ‘a’ 520 stored in the storage unit 518 of the operational unit 320 faster than to read the user information ‘A’ 506 stored in the storage unit 504 of the main unit 310.

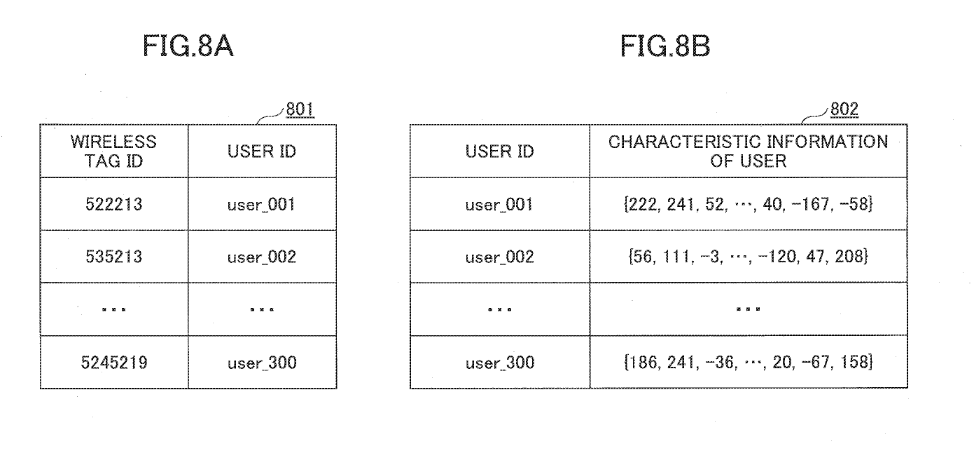

FIGS. 8A-8B are tables illustrating another example of user information according to the first embodiment.

In user information 801 illustrated in FIG. 8A, the “wireless tag ID” described above, and the “user ID” as the identification information of the user, are associated with each other and stored. The wireless authentication unit 512 can authenticate the RFID tag 104 if at least information in the user information 801 is available. For example, if the tag ID of the RFID tag 104 received by the wireless communication unit 511 is included in the user information 801, the wireless authentication unit 512 permits authentication of the RFID tag 104, and outputs a user ID that corresponds to the tag ID authenticated for permission, to the authentication unit 516 or the like. Note that the user ID is an example of identification information specific to each user.

In user information 802 illustrated in FIG. 8B, the “user ID” described above and the “characteristic information of user” are associated with each other and stored. The image authentication unit 515 can authenticate a user included in an image, for example, by using information in the user information 802. For example, if a characteristic information item that corresponds to characteristic information extracted by the characteristic information extraction unit 514 is included in the user information 802, the image authentication unit 515 permits authentication of the user included in the image, and outputs the user ID of the user authenticated for permission to the authentication unit 516 or the like.

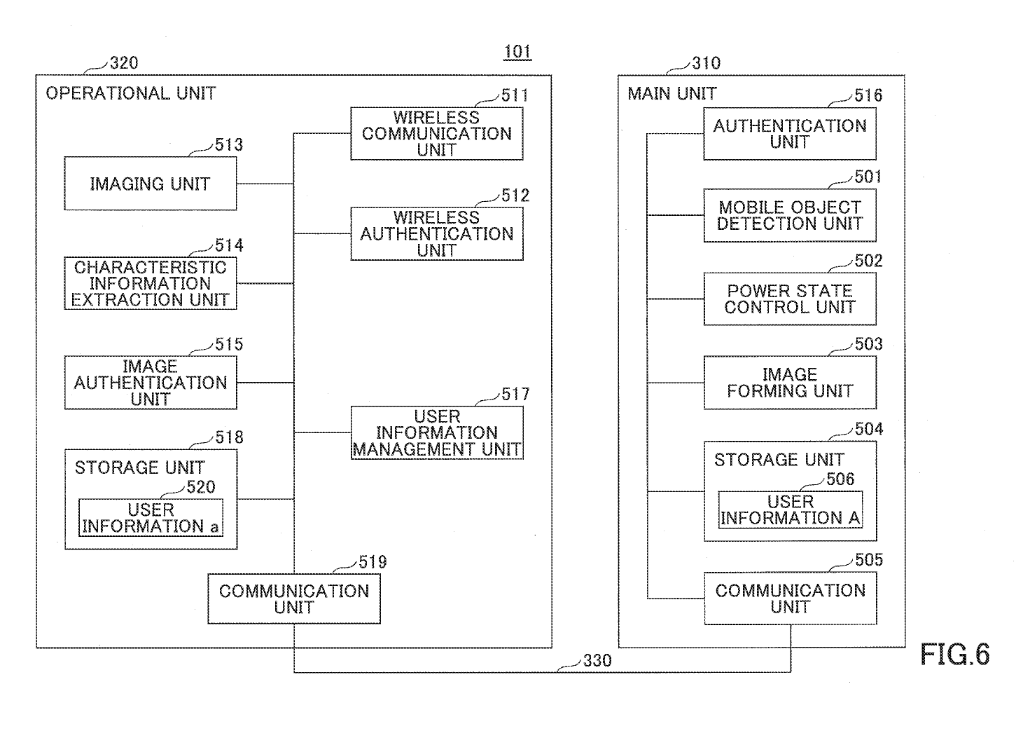

FIG. 6 is a diagram illustrating another example of a functional configuration of the image forming apparatus 101 according to the first embodiment. In the image forming apparatus 101 illustrated in FIG. 6, the authentication unit 516 is included in the main unit 310. Note that the other elements are the same as in the image forming apparatus 101 illustrated in FIG. 5. As such, the authentication unit 516 may be included in the main unit 310, or may be included in the operational unit 320.

In the configuration illustrated in FIG. 6, the wireless authentication unit 512 indicates a result of authentication by the wireless authentication unit 512 (for example, information about a user authenticated for permission) to the authentication unit 516, by using the communication unit 519. Similarly, the image authentication unit 515 indicates a result of authentication by the image authentication unit 515 (for example, information about a user authenticated for permission) to the authentication unit 516, by using the communication unit 519. Then, the authentication unit 516 authenticates the user, based on the result of authentication by the wireless authentication unit 512, and the result of authentication by the image authentication unit 515 received via the communication unit 505.

<Flows of Processes>

Next, flows of processes of the image forming apparatus 101 will be described.

(Process of Wireless Authentication Unit)

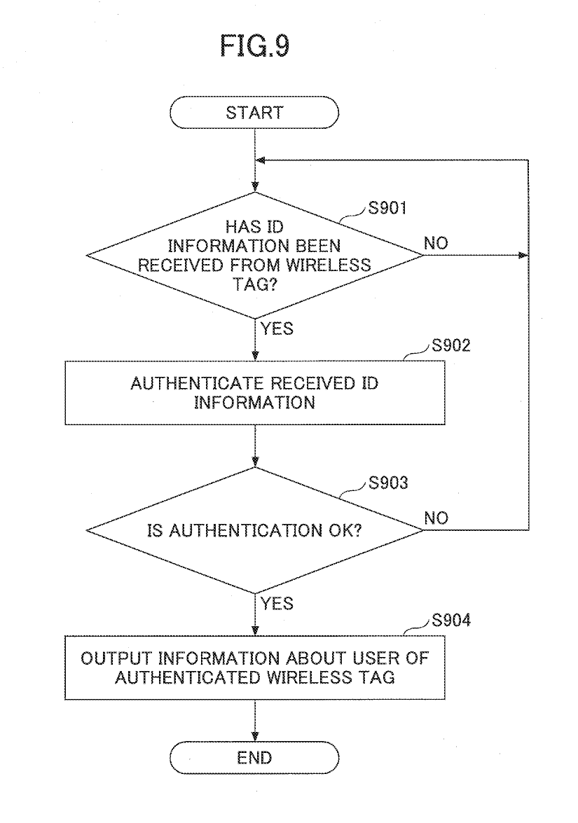

FIG. 9 is a flowchart illustrating an example of a process for authentication by the wireless authentication unit 515 according to the first embodiment.

At Step S901, if the wireless communication unit 511 receives identification information (a tag ID) from a wireless tag (an RFID tag 104), the wireless authentication unit 512 executes Steps S902 and after.

At Step S902, the wireless authentication unit 512 authenticates the identification information (the tag ID) received by the wireless communication unit 511. For example, the wireless authentication unit 512 permits authentication of the RFID tag 104 if the tag ID received by the wireless communication unit 511 is included in the “wireless tag IDs” in the user information ‘a’ 520 or the user information ‘A’ 506. On the other hand, the wireless authentication unit 512 does not permit authentication of the RFID tag 104 if the tag ID received by the wireless communication unit 511 is not included in the “wireless tag IDs” in the user information ‘a’ 520 or the user information ‘A’ 506.

At Step S903, if not having permitted the received identification information for authentication (the result of authentication is not “OK”), the wireless authentication unit 512 makes the process go back to Step S901, to repeat the step. On the other hand, if having permitted the received identification information for authentication (the result of authentication is “OK”), the wireless authentication unit 512 makes the process transition to Step S904.

After the process has transitioned to Step S904, the wireless authentication unit 512 outputs information about the user of the wireless tag (for example, identification information of the user such as the “user number” and the “user ID”) authenticated for permission (authentication was “OK”) to the authentication unit 516 or the like.

At this moment, the wireless authentication unit 512 may transmit information representing that permission has been obtained by the authentication (the result of the authentication being “OK”), along with the information about the user of the wireless tag authenticated for permission, to the authentication unit 516.

Also, at Step S903, if having rejected the received identification information for authentication, the wireless authentication unit 512 may transmit information representing that rejection has been obtained by the authentication (the result of the authentication being “NG”) to the authentication unit 516.

(Process of Image Authentication Unit)

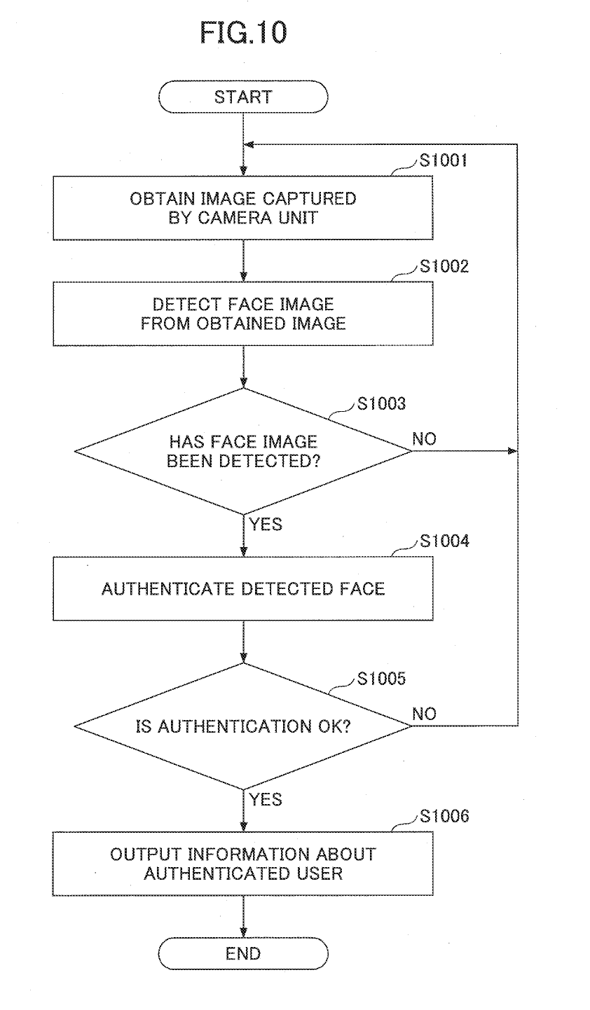

FIG. 10 is a flowchart illustrating an example of a process for authentication by the image authentication unit 515 according to the first embodiment.

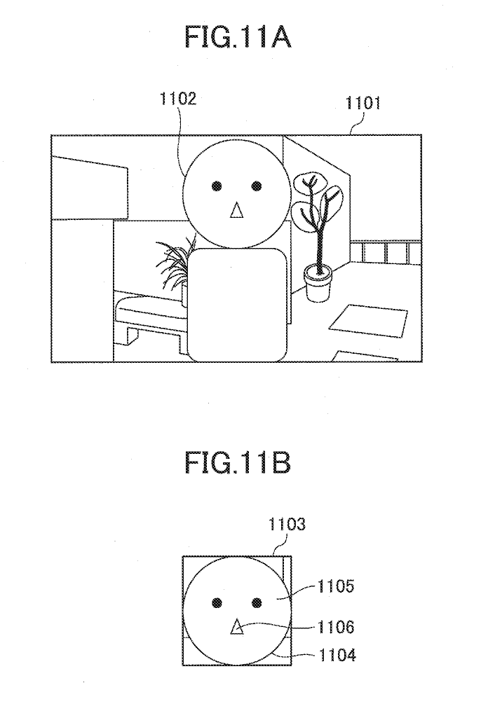

At Step S1001, the imaging unit 513 obtains an image captured by the camera unit 332. FIG. 11A illustrates an example of an image obtained at this moment.

In a captured image 1101 illustrated in FIG. 11A, an image of a user 1102 in front of the image forming apparatus 101 is captured. In this way, the camera unit 332 is installed so that the image of a user in front of the image forming apparatus 101 can be captured to be included in the image 1101.

At Step S1002, the characteristic information extraction unit 514 detects a face part image (a face image) in the image obtained at Step S1001. FIG. 11B illustrates an example of a face image detected at this moment. The characteristic information extraction unit 514 extracts, for example, a profile of the face of the user 1104, and parts such as eyes 1105 and a nose 1106 from the captured image 1101 captured by the camera unit 332, and detects a face image 1103 of the user, for example, by using a publicly known pattern matching technology or the like.

At Step S1003, the image authentication unit 515 makes the process branch off depending on whether a face image has been detected. If a face image has not been detected, the image authentication unit 515 makes the process go back to Step S1001, to repeat the same steps.

On the other hand, if a face image has been detected, the image authentication unit 515 authenticates the detected face (face authentication) at Step S1004.

Note that various publicly known face authentication technologies (see, for example, Patent Document 1) may be applied to the step of face authentication. Here, just an example will be summarized.

For example, the “characteristic information of user” in the user information ‘a’ 520 and the user information ‘A’ 506 includes characteristic information about a profile of the face of each user of the image forming apparatus 101, and shapes and relative positions of parts such as eyes, a nose, a chin, cheekbones, and the like of the user, which are obtained and stored in advance.

Also, the characteristic information extraction unit 514 extracts the face image 1103 included in the captured image 1101 obtained by the imaging unit 513, and further extracts the characteristic information of the user from the extracted face image 1103.

The image authentication unit 515 compares the characteristic information of the user extracted by the characteristic information extraction unit 514 with the above “characteristic information of the user”, item by item, to determine whether the user included in the captured image 1101 is one of the registered users in the user information ‘a’ 520 and the user information ‘A’ 506. If having determined that the user included in the captured image 1101 is one of the registered users in the user information a′ 520 and the user information ‘A’ 506, the image authentication unit 515 permits the user included in the captured image 1101 for authentication. On the other hand, determining that the user included in the captured image 1101 is not one of the registered users in the user information ‘a’ 520 and the user information ‘A’ 506, the image authentication unit 515 does not permit the user included in the captured image 1101 for authentication.

At Step S1005, the image authentication unit 515 makes the process branch off depending on a result of the authentication at Step S1004. If not having permitted the user included in the captured image 1101 for authentication (the result of authentication is not “OK”), the image authentication unit 515 makes the process go back to Step S1001, to repeat the same steps. On the other hand, if having permitted the user included in the captured image 1101 for authentication (the result of authentication is “OK”), the image authentication unit 515 makes the process transition to Step S1006.

After the process has transitioned to Step S1006, the image authentication unit 515 outputs information about the user (for example, identification information of the user such as the “user number” and the “user ID”) authenticated for permission (authentication was “OK”) to the authentication unit 516 or the like.

At this moment, the image authentication unit 515 may transmit information representing that permission has been obtained by the authentication (the result of the authentication being “OK”), along with the information about the user authenticated for permission, to the authentication unit 516.

Also, at Step S1005, if having rejected the user included in the captured image 1101 for authentication, the wireless authentication unit 512 may transmit information representing that rejection has been obtained by the authentication (the result of the authentication being “NG”) to the authentication unit 516.

(Process for Authentication by Image Forming Apparatus)

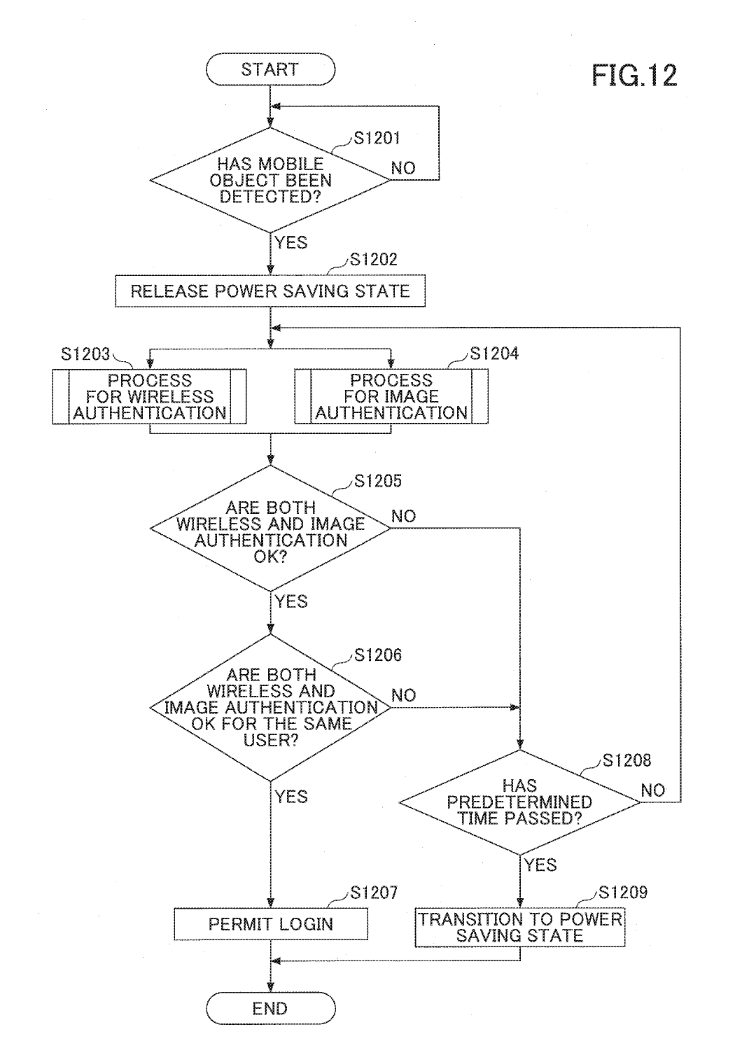

FIG. 12 is a flowchart illustrating an example of a process for authentication by the image forming apparatus 101 according to the first embodiment. Note that at start timing of a process by the flowchart illustrated in FIG. 12, the image forming apparatus 101 is assumed to be in a power-saving state described above under control of the power state control unit 502.

At Step S1201, if a mobile object around the image forming apparatus 101 is detected by the mobile object detection unit 501 of the main unit 310, the image forming apparatus 101 executes Steps S1202 and after.

After the process has transitioned to Step S1202, the power state control unit 502 of the main unit 310 releases the power-saving state of the operational unit 320. For example, the power state control unit 502 indicates a resume command to the operational unit 320 via the communication unit 505, to resume a normal state of the operational unit 320 from the power-saving state. This makes it possible to execute a process for authentication by the wireless authentication unit 512 illustrated in FIG. 9, and a process for authentication by the image authentication unit 515 illustrated in FIG. 10.

At Step S1203, the wireless communication unit 511 and the wireless authentication unit 512 of the operational unit 320 execute a process for wireless authentication, for example, as illustrated in FIG. 9.

It is assumed here that if the wireless tag is permitted for authentication by the process for wireless authentication, the wireless authentication unit 512 outputs information representing the processed result of the process for wireless authentication being “OK”, and identification information of the user of the wireless tag authenticated for permission (for example, the “user number” in FIG. 7). On the other hand, if the wireless tag is rejected for authentication by the process for wireless authentication, the wireless authentication unit 512 outputs information representing the processed result of the process for wireless authentication being “NG”.

At Step S1204, the imaging unit 513, the characteristic information extraction unit 514, and the image authentication unit 515 of the operational unit 320 execute a process for image authentication, for example, as illustrated in FIG. 10.

It is assumed here that if the user included in the captured image is permitted for authentication by the process for image authentication, the image authentication unit 515 outputs information representing the processed result of the process for image authentication being “OK”, and identification information of the user of the user authenticated for permission (for example, the “user number” in FIG. 7). On the other hand, if the user included in the captured image is rejected for authentication by the process for image authentication, the image authentication unit 515 outputs information representing the processed result of the process for image authentication being “NG”.

At Step S1205, based on the information output from the wireless authentication unit 512 and the image authentication unit 515, the authentication unit 516 determines whether the result of the process for wireless authentication is “OK” and the result of the process for image authentication is “OK” (permission).

If both the result of the process for wireless authentication and the result of the process for image authentication are “OK” (permission), the authentication unit 516 makes the process transition to Step S1206. On the other hand, if at least one of the result of the process for wireless authentication and the result of the process for image authentication is not “OK” (permission), the authentication unit 516 makes the process transition to Step S1208.

After the process has transitioned to Step S1206, the authentication unit 516 determines whether the user of the wireless tag “OK”ed by the process for wireless authentication at Step S1203 is the same user as the user “OK”ed by the process for image authentication at Step S1204. For example, the authentication unit 516 determines whether the identification information output from the wireless authentication unit 512 is equivalent to the identification information output from the image authentication unit 515.

For example, if the identification information output from the wireless authentication unit 512 is equivalent to the identification information output from the image authentication unit 515, the authentication unit 516 permits the user to log in the image forming apparatus 101 at Step S1207. This makes it possible for the user to use the image forming apparatus 101.

On the other hand, for example, if the identification information output from the wireless authentication unit 512 is not equivalent to the identification information output from the image authentication unit 515, the authentication unit 516 makes the process transition to Step S1208.

At Step S1208, the power state control unit 502 determines whether a predetermined time (for example, five minutes) has passed since the power-saving state of the operational unit 320 has been released at Step S1202.

If the predetermined time has passed (if the authentication by the authentication unit 516 has not succeeded within the predetermined time), the power state control unit 502 makes the operational unit 320 transition to a power-saving state at Step S1209.

On the other hand, if the predetermined time has not passed, the operational unit 320 makes the process go back to Steps S1203 and S1204, to repeat the steps.

By the above process, the image forming apparatus 101 executes wireless authentication of the RFID tag 104, and image authentication of the user included in a captured image captured by the imaging unit 513. Also, if the user permitted by the wireless authentication is the same user as the user permitted by the image authentication, the image forming apparatus 101 permits use of the image forming apparatus 101.

Thus, the image forming apparatus 101 can easily improve precision of authentication in a method for authentication that uses a captured image such as face authentication and the like.

### Second Embodiment

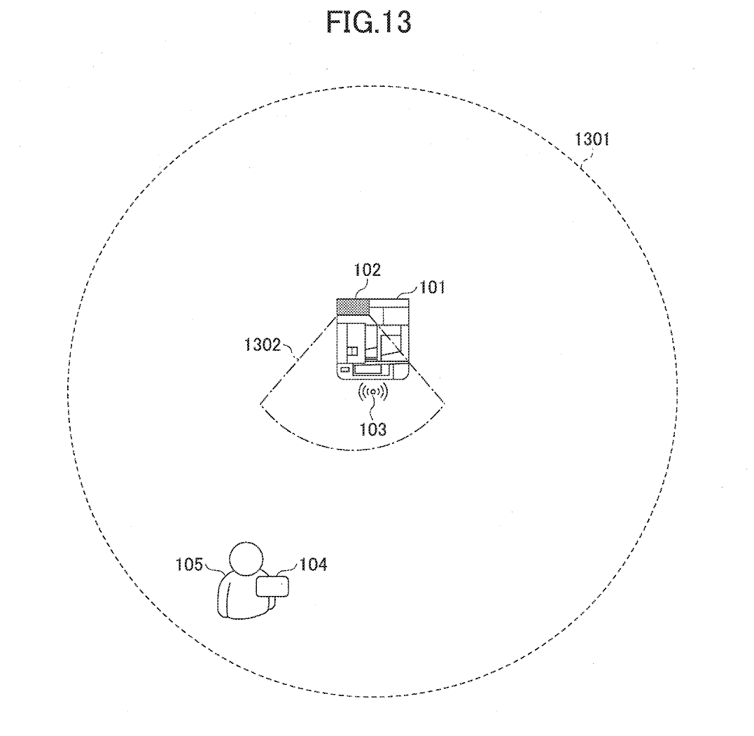

Although the first embodiment has been described assuming that the RFID tag 104 held by the user 105 is a passive RFID tag, the RFID tag 104 may be, for example, an active RFID tag. An example of a detection range of the RF tag reader 103 in this case is illustrated in FIG. 13.

FIG. 13 is a diagram illustrating an example of a detection range of the RF tag reader 103 according to a second embodiment. If the RFID tag 104 is an active tag, the detection range 1301 of the RF tag reader 103 becomes wider than in the case of a passive tag in general. This is also the same for a case where other near field communication, for example, BLE is used instead of RFID.

As such, embodiments in the present disclosure are applicable to near field communication other than a passive RFID tag. In the second embodiment, an example of a case where the RFID tag 104 executes near field communication as an active RFID tag or the like, will be described.

<Functional Configuration>

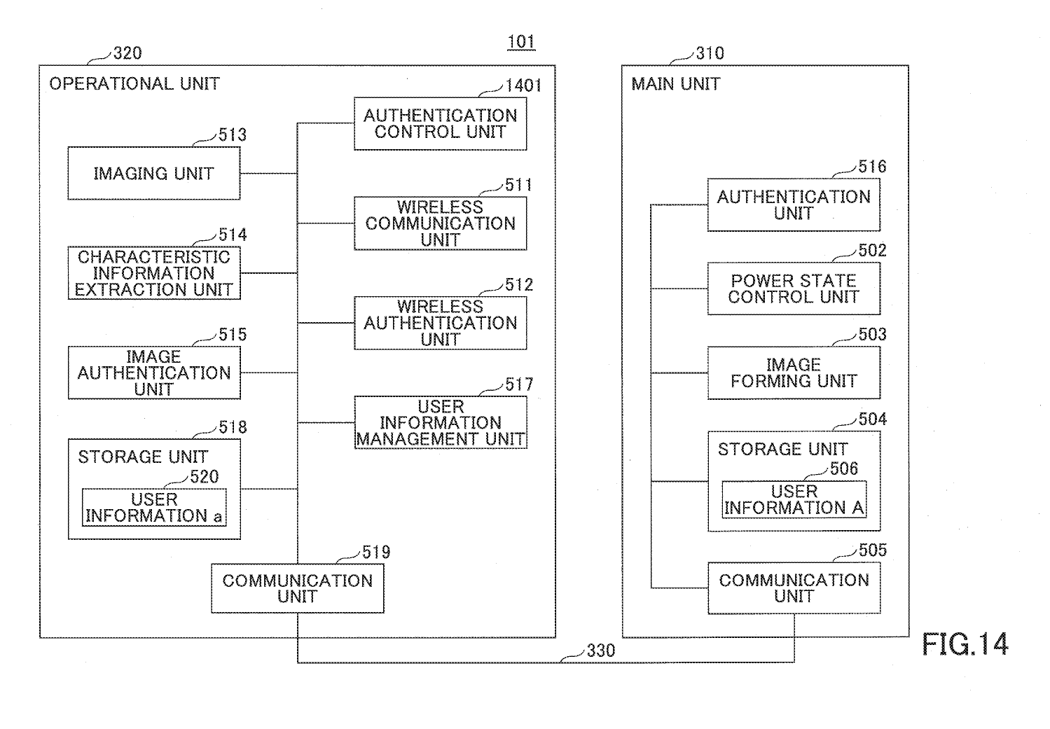

FIG. 14 is a diagram illustrating an example of a functional configuration of an image forming apparatus 101 according to the second embodiment. An operational unit 320 of the image forming apparatus 101 according to the embodiment includes, for example, an authentication control unit 1401 in addition to the elements in the operational unit 320 according to the first embodiment illustrated in FIG. 6. Note that the authentication unit 516 included in the main unit 310 in FIG. 14 may be included in the operational unit 320.

Also, the main unit 310 of the image forming apparatus 101 according to the embodiment may include a mobile object detection unit 501, or may not include a mobile object detection unit 501. In the example in FIG. 14, the main unit 310 does not include a mobile object detection unit 501. Note that other elements are the same as the elements in the functional configuration of the image forming apparatus 101 according to the first embodiment illustrated in FIG. 6, and hence, differences will be mainly described here.

The authentication control unit 1401 (an authentication control unit) has the imaging unit 513, the characteristic information extraction unit 514, and the image authentication unit 515 execute a process for image authentication if a wireless tag (for example, the RFID tag 104) has been permitted for wireless authentication by the wireless authentication unit 512.

For example, in the example in FIG. 13, there is a time difference after the user 105 has entered the detection range 1301 of the RF tag reader 103 before entering a capturing range 1302 of the camera 102. Also, if there is no RFID tag 104 permitted by the wireless authentication within the detection range of the RF tag reader 103, it is not necessary to execute image authentication by the image authentication unit 515.

Therefore, the authentication control unit 1401 may execute image authentication just if the RFID tag 104 is permitted for wireless authentication by the wireless authentication unit 512, to reduce unnecessary processes for image authentication by the operational unit 320 and power consumption.

Also, the wireless tag may be an IC card or an IC tag, to which a wireless authentication unit (the wireless authentication unit 512) may apply wireless authentication by using an IC card/IC tag reader. In this case, the user first has a wireless tag (an IC card or an IC tag) held above or contacting an IC card/IC tag reader of the image forming apparatus 101 to be permitted for wireless authentication, and then, proceeds to image authentication.

<Flow of Process>

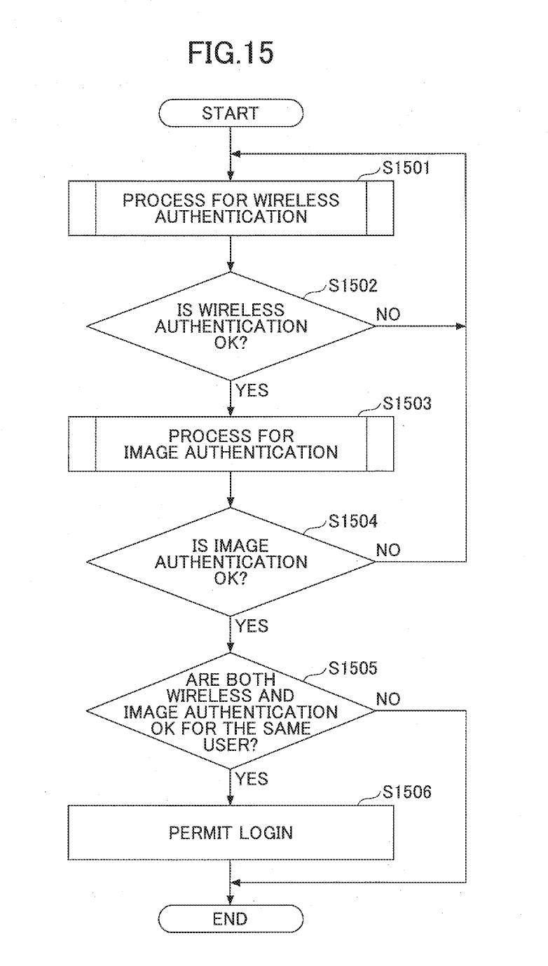

FIG. 15 is a flowchart illustrating an example of a process for authentication by the image forming apparatus 101 according to the second embodiment.

At Step S1501, the wireless communication unit 511 and the wireless authentication unit 512 of the operational unit 320 execute a process for wireless authentication, for example, illustrated in FIG. 9. Also, it is assumed that the wireless authentication unit 512 according to the embodiment indicates identification information about the user of the wireless tag OKed by wireless authentication (for example, the “user number” or the “user ID”) to the authentication unit 516.

At Step S1502, if permission is obtained for wireless authentication by the wireless authentication unit 512, the authentication control unit 1401 executes a process for image authentication at Step S1503. On the other hand, if permission is not obtained for wireless authentication by the wireless authentication unit 512, the authentication control unit 1401 makes the process go back to Step S1501, to repeat the same steps.

After the process has transitioned to Step S1503, the imaging unit 513, the characteristic information extraction unit 514, and the image authentication unit 515 of the operational unit 320 execute a process for image authentication, for example, illustrated in FIG. 10. Also, it is assumed that the image authentication unit 515 according to the embodiment indicates identification information about the user of the wireless tag OKed by wireless authentication (for example, the “user number” or the “user ID”) to the authentication unit 516.

At Step S1505, the authentication unit 516 determines whether the user of the wireless tag permitted for wireless authentication the wireless authentication unit 512 is the same user as (equivalent to) the user permitted for image authentication the image authentication unit 515.

If having determined that the user of the wireless tag permitted for wireless authentication the wireless authentication unit 512 is the same user as the user permitted for image authentication the image authentication unit 515, the authentication unit 516 permits the user to log in. On the other hand, if having determined that the user of the wireless tag permitted for wireless authentication the wireless authentication unit 512 is not the same user as the user permitted for image authentication the image authentication unit 515, the authentication unit 516 does not permit the user to log in.

By the above process, the image forming apparatus 101 has the wireless authentication unit 512 execute the image authentication if the RFID tag 104 has been permitted by the wireless authentication, and hence, can reduce unnecessary processes for image authentication by the operational unit 320, and power consumption.

### Third Embodiment

For example, the image forming apparatus 101 according to the first embodiment does not permit the user for authentication unless permission is obtained by both the wireless authentication by the wireless authentication unit 512 and the image authentication by the image authentication unit 515. Therefore, if permission has been obtained by one of the authentications, but permission is not obtained by the other authentication within a predetermined time, it is desirable that the authentication unit 516 releases the authentication of the partly permitted user (for example, deletes the stored identification information).

For example, assume that a user not holding the RFID tag 104 stands in front of the image forming apparatus 101, and obtains permission for image authentication. In this case, the authentication unit 516 receives identification information of the user permitted for image authentication from the image authentication unit 515 (for example, the “user number” or the “user ID”). However, since the user does not hold the RFID tag 104, the user cannot not be permitted for wireless authentication even if the predetermined time (for example, five minutes) has passed. In such a case, it is desirable that if the predetermined time has passed since having received the identification information of the user permitted by the image authentication, the authentication unit 516 releases the received authentication of the user (for example, deletes identification information obtained from the image authentication unit 515).

Also, for example, assume that a user holding the RFID tag 104 comes in front of the image forming apparatus 101, and is permitted for wireless authentication by the wireless authentication unit 512, but passes by in front of the image forming apparatus 101. In this case, the authentication unit 516 receives identification information of the user permitted for wireless authentication from the wireless authentication unit 512 (for example, the “user number” or the “user ID”). However, since the user has just passed by in front of the image forming apparatus 101, the user cannot not be permitted for image authentication even if the predetermined time (for example, five minutes) has passed. In such a case, it is desirable that if the predetermined time has passed since having received the identification information of the user of the wireless tag permitted for wireless authentication, the authentication unit 516 releases the received authentication of the user (for example, deletes identification information obtained from the wireless authentication unit 512).

<Flow of Process>

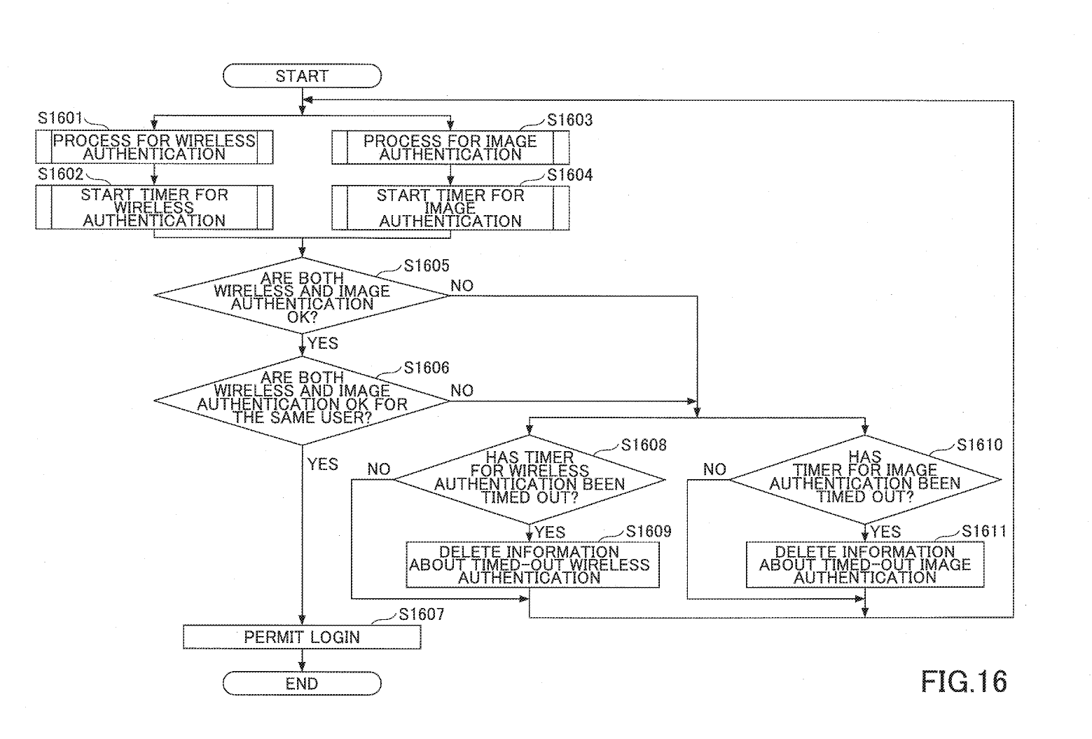

FIG. 16 is a flowchart illustrating an example of a process for authentication by the image forming apparatus 101 according to the third embodiment. Note that the basic flow of the process is substantially the same as the process for authentication by the image forming apparatus 101 according to the first embodiment illustrated in FIG. 12, and detailed description will be omitted.

At Step S1601, the wireless communication unit 511 and the wireless authentication unit 512 of the operational unit 320 execute a process for wireless authentication, for example, illustrated in FIG. 9.

It is assumed here that if the wireless tag is permitted for authentication by the process for wireless authentication, the wireless authentication unit 512 outputs information representing the processed result of the process for wireless authentication being “OK”, and identification information of the user of the wireless tag authenticated for permission (for example, the “user number” in FIG. 7).

At Step S1602, in response to receiving the information representing the processed result of the process for wireless authentication being “OK”, and the identification information of the user of the wireless tag authenticated for permission output by the wireless authentication unit 512, the authentication unit 516 starts a timer for wireless authentication for the wireless tag authenticated for permission this time.

At Step S1603, the imaging unit 513, the characteristic information extraction unit 514, and the image authentication unit 515 of the operational unit 320 execute a process for image authentication, for example, illustrated in FIG. 10.

It is assumed here that if the user included in the captured image is permitted for authentication by the process for image authentication, the image authentication unit 515 outputs information representing the processed result of the process for image authentication being “OK”, and identification information of the user of the user authenticated for permission (for example, the “user number” in FIG. 7).

At Step S1604, in response to receiving the information representing the processed result of the process for image authentication being “OK”, and the identification information of the user authenticated for permission output by the image authentication unit 515, the authentication unit 516 starts a timer for image authentication for the user authenticated for permission this time.

At Step S1605, based on the information output from the wireless authentication unit 512 and the image authentication unit 515, the authentication unit 516 determines whether the result of the process for wireless authentication is “OK” and the result of the process for image authentication is “OK”.

If both the result of the process for wireless authentication and the result of the process for image authentication are “OK” (permission), the authentication unit 516 makes the process transition to Step S1606. On the other hand, if at least one of the result of the process for wireless authentication and the result of the process for image authentication is not “OK” (permission), the authentication unit 516 makes the process transition to Steps S1608 and S1610.

After the process has transitioned to Step S1606, the authentication unit 516 determines whether the user of the wireless tag “OK”ed by the process for wireless authentication at Step S1601 is the same user as the user “OK”ed by the process for image authentication at Step S1603. For example, the authentication unit 516 determines whether the “user number” output from the wireless authentication unit 512 is equivalent to the “user number” output from the image authentication unit 515.

If the “user number” output from the wireless authentication unit 512 is equivalent to the “user number” output from the image authentication unit 515, the authentication unit 516 permits the user to log in the image forming apparatus 101 at Step S1607. This makes it possible for the user to use the image forming apparatus 101.

On the other hand, if the “user number” output from the wireless authentication unit 512 is not equivalent to the “user number” output from the image authentication unit 515, the authentication unit 516 makes the process transition to Steps S1608 and S1610.

At Step S1608, the authentication unit 516 determines whether the timer for wireless authentication started at Step S1602 has been timed out.

If the timer for wireless authentication has been timed out, the authentication unit 516 deletes the identification information of the user of the wireless tag that has been received to have the timer for wireless authentication start at Step S1602 (releases the authentication), and makes the process transition to Steps S1601 and S1603.

On the other hand, if the timer for wireless authentication has not been timed out, the authentication unit 516 makes the process transition to Steps S1601 and S1603.

At Step S1610, the authentication unit 516 determines whether the timer for image authentication started at Step S1604 has been timed out.

If the timer for image authentication has been timed out, the authentication unit 516 deletes the identification information of the user that has been received to have the timer for image authentication start at Step S1604 (releases the authentication), and makes the process transition to Steps S1601 and S1603.

On the other hand, if the timer for image authentication has not been timed out, the authentication unit 516 makes the process transition to Steps S1601 and S1603.

By the above process, the authentication unit 516 can easily delete unnecessary user information.

### Fourth Embodiment

A wireless authentication unit 512 according to this embodiment executes wireless authentication of the RFID tag 104 by using the user information ‘a’ 520 stored in the storage unit 518 of the operational unit 320. This makes it possible for the wireless authentication unit 512 to execute wireless authentication of the RFID tag 104, without activating the storage unit 314 of the main unit 310, or waiting for data to be transferred from the main unit 310.

Also, if the RFID tag 104 is not permitted for wireless authentication based on the user information ‘a’ 520, the wireless authentication unit 512 executes wireless authentication of the RFID tag 104 by using the user information ‘A’ 506 stored in the storage unit 504 of the main unit 310. This makes it possible for the wireless authentication unit 512 to authenticate a greater number of users than users stored in the storage unit 518 of the operational unit 320.

Similarly, the image authentication unit 515 according to the embodiment executes image authentication of a user included in a captured image by using the user information ‘a’ 520 stored in the storage unit 518 of the operational unit 320. This makes it possible for the wireless authentication unit 512 to execute image authentication of the user included in the captured image, without activating the storage unit 314 of the main unit 310, or waiting for data to be transferred from the main unit 310.

Also, if the user included in the captured image is not permitted by the image authentication based on the user information ‘a’ 520, the wireless authentication unit 512 executes image authentication of the user included in the captured image by using the user information ‘A’ 506 stored in the storage unit 504 of the main unit 310. This makes it possible for the wireless authentication unit 512 to authenticate a greater number of users than users stored in the storage unit 518 of the operational unit 320.

<Flow of Process>

(Process for Wireless Authentication)

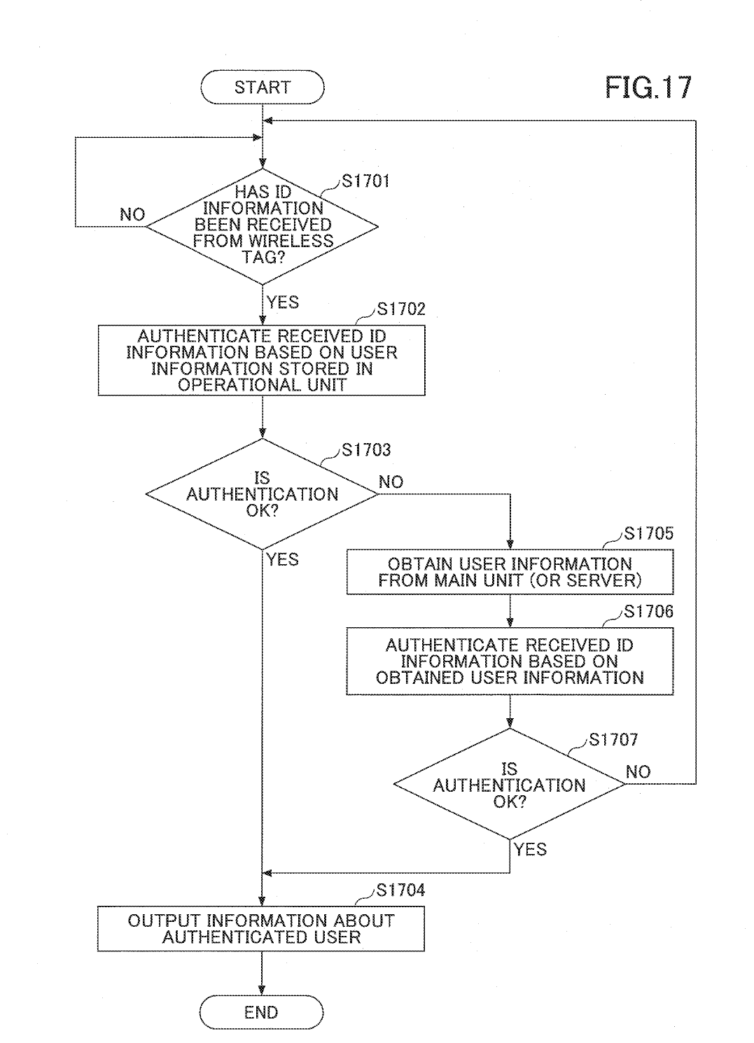

FIG. 17 is a flowchart illustrating an example of a process for authentication by the wireless authentication unit 512 according to the fourth embodiment.

At Step S1701, if the wireless communication unit 511 receives identification information (a tag ID) from a wireless tag (an RFID tag 104), the wireless authentication unit 512 executes Steps 1702 and after.

At Step S1702, the wireless authentication unit 512 authenticates the identification information (the tag ID) received by the wireless communication unit 511, based on the user information ‘a’ 520 stored in the storage unit 518 of the operational unit 320. For example, the wireless authentication unit 512 permits authentication of the RFID tag 104 if the tag ID received by the wireless communication unit 511 is included in the “wireless tag IDs” in the user information ‘a’ 520. On the other hand, the wireless authentication unit 512 does not permit authentication of the RFID tag 104 if the tag ID received by the wireless communication unit 511 is not included in the “wireless tag IDs” in the user information ‘a’ 520.

At Step S1703, the wireless authentication unit 512 makes the process branch off depending on a result of the authentication at Step S1702.

If having permitted authentication of the RFID tag 104, the wireless authentication unit 512 makes the process transition to Step S1704, and outputs information about the user of the RFID tag 104 authenticated for permission (identification information of the user).

On the other hand, if not having permitted authentication of the RFID tag 104, the wireless authentication unit 512 makes the process transition to Step S1705.

After the process has transitioned to Step S1705, the wireless authentication unit 512 obtains the user information ‘A’ 506 stored in the storage unit 504 of the main unit 310 from the main unit 310, for example, by the user information management unit 517. Note that the user information ‘A’ 506 may be obtained from, for example, an external server connected via the network 340 or a cloud service.

At Step S1706, based on the user information ‘A’ 506 obtained by the user information management unit 517, the wireless authentication unit 512 authenticates the identification information (the tag ID) received by the wireless communication unit 511.

At Step S1707, the wireless authentication unit 512 makes the process branch off depending on a result of authentication at Step S1706.

If having permitted authentication of the RFID tag 104, the wireless authentication unit 512 makes the process transition to Step S1704, and outputs information about the user of the RFID tag 104 authenticated for permission (identification information of the user).

On the other hand, if not having permitted authentication of the RFID tag 104, the wireless authentication unit 512 makes the process go back to Step S1701, to repeat the same steps.

By the above process, the wireless authentication unit 512 according to the embodiment can execute the wireless authentication of the RFID tag 104, without activating the storage unit 314 of the main unit 310, or waiting for data to be transferred from the main unit 310. Also, the wireless authentication unit 512 can authenticate a greater number of users than users stored in the storage unit 518 of the operational unit 320.

(Process for Image Authentication)

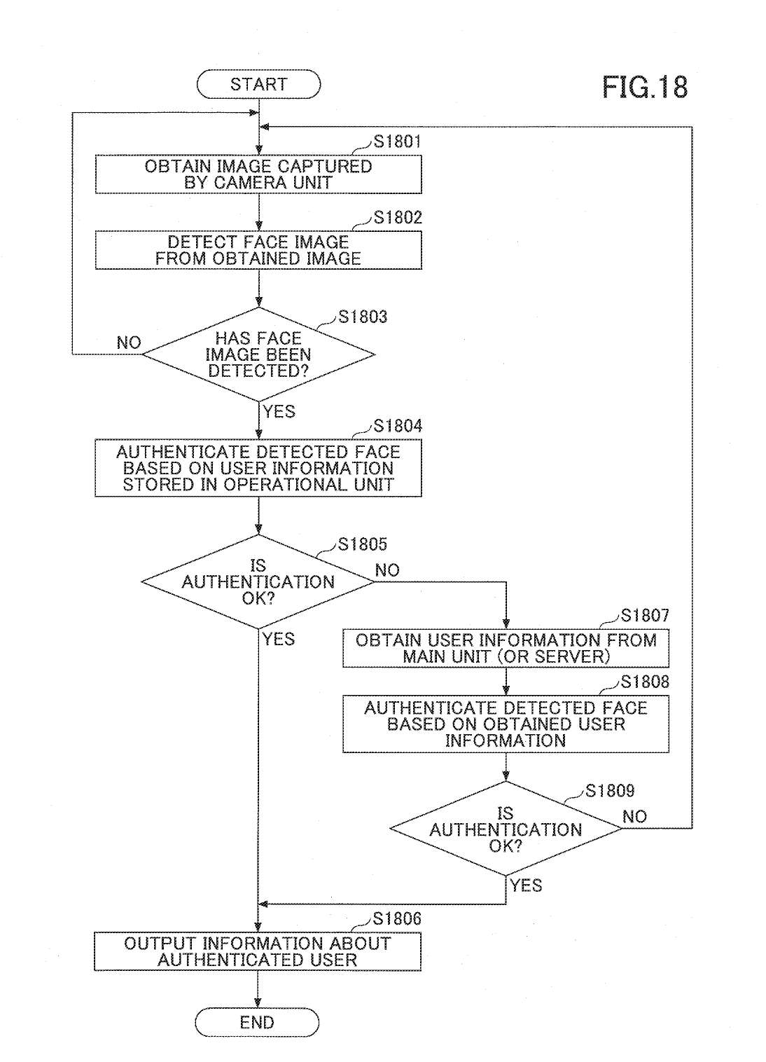

FIG. 18 is a flowchart illustrating an example of a process for authentication by the image authentication unit 101 according to the fourth embodiment. Note that the basic flow of the process is substantially the same as the process for authentication by the image forming apparatus 101 according to the first embodiment illustrated in FIG. 10, and detailed description will be omitted.

At Step S1801, the imaging unit 513 obtains an image captured by the camera unit 332.

At Step S1802, the characteristic information extraction unit 514 detects a face part image (a face image) in the image obtained at Step S1801.

At Step S1803, the image authentication unit 515 makes the process branch off depending on whether a face image has been detected.

If a face image has not been detected, the image authentication unit 515 makes the process go back to Step S1801, to repeat the same steps.

On the other hand, if a face image has been detected, the image authentication unit 515 authenticates the detected face (face authentication) at Step S1004, based on the user information ‘a’ 520 stored in the storage unit 518 of the operational unit 320 (face authentication).

At Step S1805, the image authentication unit 515 makes the process branch off depending on a result of the authentication at Step S1804.

If the detected face is authenticated for permission, the wireless authentication unit 512 makes the process transition to Step S1806, and outputs information about the user authenticated for permission (identification information of the user).

On the other hand, if the detected face is not authenticated for permission, the wireless authentication unit 512 makes the process transition to Step S1807.

After the process has transitioned to Step S1807, the image authentication unit 515 obtains the user information ‘A’ 506 stored in the storage unit 504 of the main unit 310 from the main unit 310, for example, by the user information management unit 517. Note that the user information ‘A’ 506 may be obtained from, for example, an external server connected via the network 340 or a cloud service.

At Step S1808, the image authentication unit 515 authenticates the detected face based on the user information ‘A’ 506 obtained by the user information management unit 517 (face authentication).

At Step S1809, the image authentication unit 515 makes the process branch off depending on a result of the authentication at Step S1808.

If the detected face is authenticated for permission, the image authentication unit 515 makes the process transition to Step S1806, and outputs information about the user authenticated for permission (identification information of the user).

On the other hand, if the detected face is not authenticated for permission, the image authentication unit 515 makes the process go back to Step S1801, to repeat the same steps.

By the above process, the image authentication unit 515 according to the embodiment can execute the image authentication of the user included in the captured image, without activating the storage unit 314 of the main unit 310, or waiting for data to be transferred from the main unit 310. Also, the image authentication unit 515 can authenticate a greater number of users than users stored in the storage unit 518 of the operational unit 320.

### Fifth Embodiment

In the second embodiment, an example of a case has been described in which the image forming apparatus 101 executes image authentication by the image authentication unit 515 if permission has been obtained for wireless authentication by the wireless authentication unit 512.

In the fifth embodiment, an example of a case will be described in which the image forming apparatus 101 executes wireless authentication by the wireless authentication unit 512 if permission has been obtained for image authentication by the image authentication unit 515.

<Functional Configuration>

The functional configuration of the image forming apparatus 101 according to the fifth embodiment may be substantially the same as, for example, the functional configuration of the image forming apparatus 101 according to the second embodiment illustrated in FIG. 14. Note that the authentication unit 516 included in the main unit 310 in FIG. 14 may be included in the operational unit 320.

In the embodiment, the authentication control unit 1401 illustrated in FIG. 14 has the wireless communication unit 511 and the wireless authentication unit 512 execute a process for wireless authentication after permission has been obtained for image authentication by the image authentication unit 515.

Thus, even if the image authentication has been executed before the wireless authentication because a radio wave of the RFID tag 104 cannot be detected, the image forming apparatus 101 can start detecting the RFID tag 104 upon the image authentication, and can start the wireless authentication. Therefore, the image forming apparatus 101 can reduce unnecessary waiting time of the user.

Note that the authentication control unit 1401 (an authentication control unit) is implemented, for example, by a program run on the CPU 321 or the CPU 311 in FIG. 3.

<Flow of Process>

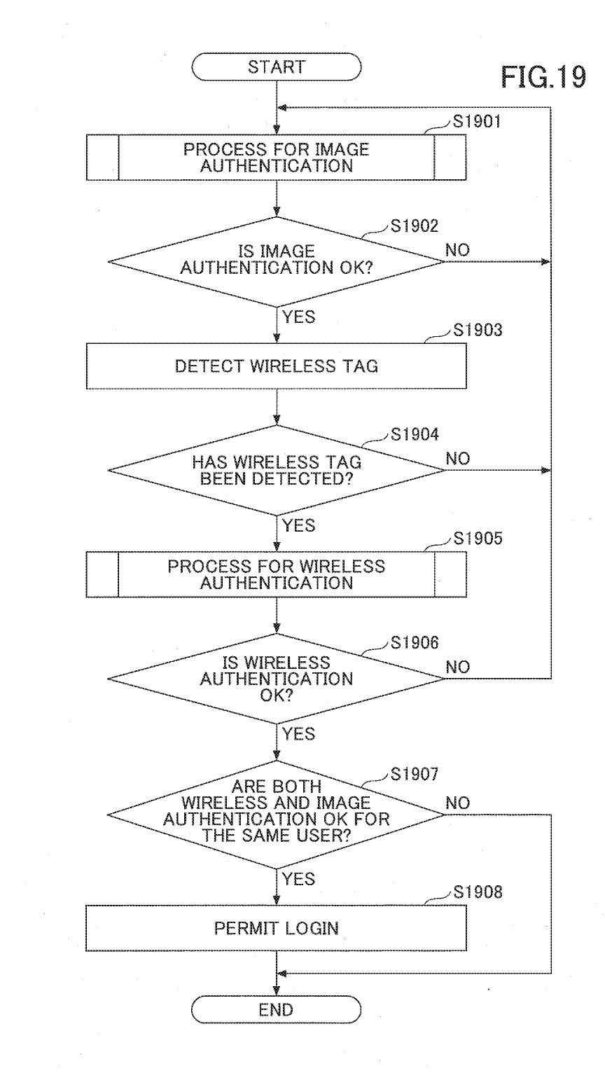

FIG. 19 is a flowchart illustrating an example of a process for authentication by the image forming apparatus 101 according to the fifth embodiment.

At Step S1901, the imaging unit 513, the characteristic information extraction unit 514, and the image authentication unit 515 of the operational unit 320 execute a process for image authentication, for example, illustrated in FIG. 10. Also, it is assumed that the image authentication unit 515 according to the embodiment indicates (outputs) identification information about the user OKed for image authentication (for example, the “user number” or the “user ID”) to the authentication unit 516.

At Step S1902, the authentication control unit 1401 makes the process branch off depending on permission is obtained for image authentication by the image authentication unit 515.

If permission is not obtained for image authentication by the image authentication unit 515 (image authentication is not “OK”), the authentication control unit 1401 makes the process go back to Step S1901. On the other hand, if permission has been obtained for image authentication by the image authentication unit 515 (image authentication is “OK”), the authentication control unit 1401 makes the process transition to Step S1903.

After the process has transitioned to Step S1903, the wireless communication unit 511 of the operational unit 320 starts detecting a wireless tag (the RFID tag 104). For example, the wireless communication unit 511 determines whether a radio wave can be detected that may be transmitted from the RFID tag 104 in the detection range 201 of the RF tag reader 103 in FIG. 2.

At Step S1904, the authentication control unit 1401 makes the process branch off depending on whether a wireless tag has been detected at Step S1903.

If a wireless tag has not been detected, the authentication control unit 1401 makes the process go back to Step S1901. On the other hand, if a wireless tag has been detected, the authentication control unit 1401 makes the process transition to Step S1905.

After the process has transitioned to Step S1905, the wireless authentication unit 512 of the operational unit 320 executes a process for wireless authentication, for example, illustrated in FIG. 9. Also, it is assumed that the wireless authentication unit 512 according to the embodiment indicates (outputs) identification information about the user of the wireless tag OKed for wireless authentication (for example, the “user number” or the “user ID”) to the authentication unit 516.

At Step S1906, the authentication control unit 1401 makes the process branch off depending on whether permission has been obtained for wireless authentication by the wireless authentication unit 512.

If permission has not been obtained for wireless authentication by the wireless authentication unit 512 (wireless authentication is not “OK”), the authentication control unit 1401 makes the process go back to Step S1901. On the other hand, if permission has been obtained for wireless authentication by the wireless authentication unit 512 (wireless authentication is “OK”), the authentication control unit 1401 makes the process transition to Step S1907.

After the process has transitioned to Step S1907, the authentication unit 516 determines whether the user “OK”ed for image authentication by the image authentication unit 515 is the same user as the user “OK”ed for wireless authentication by the wireless authentication unit 512. For example, the authentication unit 516 determines whether the identification information indicated from the image authentication unit 515, and the identification information indicated from the wireless authentication unit 512, are identification information about the same user.

If the user “OK”ed for image authentication by the image authentication unit 515 is not equivalent to the user “OK”ed for wireless authentication by the wireless authentication unit 512, the authentication unit 516 ends the process.

On the other hand, if the user “OK”ed for image authentication by the image authentication unit 515 is equivalent to the user “OK”ed for wireless authentication by the wireless authentication unit 512, the authentication unit 516 makes the process transition to Step S1908.

After the process has transitioned to Step S1908, the authentication unit 516 permits the user to log in the image forming apparatus 101. This makes it possible for the user to use the image forming apparatus 101.

By the above process, the image forming apparatus 101 has the image authentication unit 515 execute wireless authentication if permission has been obtained by the image authentication, and hence, can reduce unnecessary processes for wireless authentication by the operational unit 320 and power consumption.

Also, even if the image authentication has been executed before the wireless authentication because a wireless tag cannot be detected, the image forming apparatus 101 can start detecting a wireless tag upon the image authentication, and can start the wireless authentication. Therefore, the image forming apparatus 101 can reduce unnecessary waiting time of the user.

Also, the wireless tag may be an IC card or an IC tag, to which a wireless authentication unit (the wireless authentication unit 512) may apply wireless authentication by using an IC card/IC tag reader. In this case, the user first goes through the image authentication, and then, has a wireless tag (an IC card or an IC tag) held above or contacting an IC card/IC tag reader, to be permitted for wireless authentication.

### Supplementary Description of Embodiments

Functions of the units of the image forming apparatus 101 according to the above embodiments (for example, the wireless communication unit 511, the wireless authentication unit 512, the imaging unit 513, the characteristic information extraction unit 514, the image authentication unit 515, the authentication unit 516, the user information management unit 517, and the authentication control unit 1401) are implemented by having the CPU 311 or the CPU 321 run a program(s) stored in the storage device(s) (for example, the storage unit 314, the flash memory unit 324, the ROM 312, and the ROM 322). However, the implementation is not limited as such; at least a part of the functions of the units of the above image forming apparatus 101 may be implemented by, a dedicated hardware circuit (for example, a semiconductor integrated circuit).

Also, although the main unit 310 and the operational unit 320 independently operate on different operating systems in the above embodiments, the main unit 310 and the operational unit 320 are not limited as such; for example, the main unit 310 and the operational unit 320 may operate on the same operating system.

Also, the program(s) executed by the image forming apparatus 101 in the above embodiments may be configured to be recorded on a computer-readable recording medium, such as various optical disks, magnetic media, and USB memories, to be provided as a file(s) in an installable format or an executable format. Alternatively, the program(s) executed by the image forming apparatus 101 in the above embodiments may be configured to be provided or distributed via a network such as the Internet. Also, the program(s) may be configured to be installed in advance on a non-volatile recording medium such as a ROM, to be provided.

Summary

As described above, an information processing apparatus (101) according to an embodiment includes a wireless communication unit (511) configured to obtain predetermined information from a wireless tag (104); a wireless authentication unit (512) configured to authenticate the wireless tag (104), based on the obtained predetermined information and first user information (520 or 801) registered in advance; an imaging unit (513) configured to capture an image by using an imaging device (102); an image authentication unit (515) configured to authenticate a user captured in the image, based on the captured image and second user information (520 or 802) registered in advance; an apparatus authentication unit (516) configured to permit a user to use the information processing apparatus in a case where a user of the wireless tag (104) authenticated for permission by the wireless authentication unit (512), is a same user as the user authenticated for permission by the image authentication unit (515).

Thus, the information processing apparatus (101) permits the user to log in, in a case where permission has been obtained both for wireless authentication by a wireless tag (104), and for image authentication by the captured image, and the user permitted for the wireless authentication is the same user as the user permitted for the image authentication. Therefore, the information processing apparatus (101) according to an embodiment in the present disclosure can easily improve precision of authentication in a method for authentication that uses a captured image such as face authentication and the like.

Note that reference codes in the above parentheses are attached to make the description understandable and just examples, not intended to limit the scope of the present disclosure.

### RELATED-ART DOCUMENTS

### Patent Documents

[Patent Document 1] Japanese Laid-open Patent Publication No. 2015-35178

The present application claims priority under 35 U.S.C. §119 to Japanese Patent Application No. 2015-157784, filed Aug. 7, 2015, and Japanese Patent Application No. 2016-109031, filed May 31, 2016. The contents of which are incorporated herein by reference in their entirety.

What is claimed is:

1. An information processing apparatus, comprising:
a wireless communication unit configured to obtain predetermined information from a wireless tag;
a wireless authentication unit configured to authenticate the wireless tag, based on the obtained predetermined information and first user information registered in advance;
an imaging unit configured to capture an image by using an imaging device;
an image authentication unit configured to authenticate a user captured in the image, based on the captured image and second user information registered in advance; and
an apparatus authentication unit configured to permit a user to use the information processing apparatus in a case where a user of the wireless tag authenticated for permission by the wireless authentication unit, is a same user as the user authenticated for permission by the image authentication unit.

2. The information processing apparatus according to claim 1, wherein the first user information includes identification information specific to each user, and the predetermined information that corresponds to the identification information,
wherein the wireless authentication unit outputs the identification information of the user of the wireless tag authenticated for permission by the wireless authentication unit.

3. The information processing apparatus according to claim 2, wherein the second user information includes identification information specific to each user, and characteristic information about a living body part of the user corresponding to the identification information,
wherein the image authentication unit outputs the identification information of the user authenticated for permission by the image authentication unit.

4. The information processing apparatus according to claim 3, wherein the apparatus authentication unit permits the user to use the information processing apparatus in a case where the identification information of the user of the wireless tag authenticated for permission by the wireless authentication unit, and the identification information of the user authenticated for permission by the image authentication unit, are identification information about the same user.

5. The information processing apparatus according to claim 3, wherein the apparatus authentication unit executes authentication by using the identification information of the user obtained from the wireless authentication unit, and after a predetermined time passes, releases the authentication of the user authenticated by the wireless authentication unit.

6. The information processing apparatus according to claim 3, wherein the apparatus authentication unit executes authentication by using the identification information of the user obtained from the image authentication unit, and after a predetermined time passes, releases the authentication of the user authenticated by the image authentication unit.

7. The information processing apparatus according to claim 1, further comprising:
a storage unit configured to store at least a part of the first user information,
wherein the wireless authentication unit authenticates the wireless tag based on the information stored in the storage unit and the obtained predetermined information, and if permission is not obtained by the authentication, authenticates the wireless tag based on the first user information and the obtained predetermined information.

8. The information processing apparatus according to claim 1, further comprising:
a storage unit configured to store at least a part of the second user information,
wherein the image authentication unit authenticates the user captured in the image based on the information stored in the storage unit and the image captured by the imaging unit, and if permission is not obtained by the authentication, authenticates the user based on the second user information and the image captured by the imaging unit.

9. The information processing apparatus according to claim 1, further comprising:
an authentication control unit configured to have the image authentication unit execute authentication after permission has been obtained by the wireless authentication unit.

10. The information processing apparatus according to claim 1, further comprising:
an authentication control unit configured to have the wireless authentication unit execute authentication after permission has been obtained by the image authentication unit.

11. The information processing apparatus according to claim 9, further comprising:
a characteristic information extraction unit configured to extract characteristic information of a living body part from the image captured by the imaging unit,
wherein the image authentication unit authenticates the user captured in the image, by using the characteristic information of the living body part extracted by the characteristic information extraction unit, and the characteristic information of the living body part included in the second user information,
wherein the authentication control unit has the imaging unit, the characteristic information extraction unit, and the image authentication unit function in a case where permission has been obtained by the authentication by the wireless authentication unit.

12. The information processing apparatus according to claim 10, wherein the authentication control unit has the wireless communication unit and the wireless authentication unit function in a case where permission has been obtained by the authentication by the image authentication unit.

13. The information processing apparatus according to claim 1, wherein the predetermined information includes identification information of the wireless tag or the user of the wireless tag.

14. The information processing apparatus according to claim 1, wherein the wireless tag is an RFID tag, and the predetermined information is identification information of the RFID tag.

15. The information processing apparatus according to claim 1, wherein the wireless authentication unit authenticates the wireless tag for permission in a case where the predetermined information received from the wireless tag is included in the first user information.

16. The information processing apparatus according to claim 1, wherein the image authentication unit executes face authentication of the user captured in the image, based on a face image included in the captured image.

17. The information processing apparatus according to claim 1, wherein the information processing apparatus is an image forming apparatus that includes
a near-field communication device configured to receive the predetermined information from the wireless tag, and
the imaging device.

18. A method for authentication, executed by an information processing apparatus, the method comprising:
obtaining predetermined information from a wireless tag;
wirelessly authenticating the wireless tag, based on the obtained predetermined information and first user information registered in advance;
capturing an image by using an imaging device;
authenticating a user captured in the image, based on the captured image and second user information registered in advance; and
permitting a user to use the information processing apparatus in a case where a user of the wireless tag permitted by the wirelessly authenticating, is a same user as the user permitted by the authenticating based on the captured image.

19. A non-transitory computer-readable recording medium having a program stored therein for causing the information processing apparatus to execute the method for authentication according to claim 18.

20. An information processing system, comprising:
a near-field communication device configured to receive predetermined information from a wireless tag;
an imaging device configured to capture an image; and
an information processing apparatus configured to be connected with the near-field communication device and the imaging device,
wherein the information processing apparatus includes
a wireless communication unit configured to obtain the predetermined information received by the near-field communication device,
a wireless authentication unit configured to authenticate the wireless tag, based on the obtained predetermined information and first user information registered in advance,
an imaging unit configured to capture an image by using the imaging device,
an image authentication unit configured to authenticate a user captured in the image, based on the captured image and second user information registered in advance, and
an apparatus authentication unit configured to permit a user to use the information processing apparatus in a case where a user of the wireless tag authenticated for permission by the wireless authentication unit, is a same user as the user authenticated for permission by the image authentication unit.
